(19) United States
(12) Patent Application Publication
(10) Pub. No.: US 2021/0292588 A1
(43) Pub. Date: Sep. 23, 2021

(54) PROCESS FOR THE PRODUCTION OF STRONGLY ADHERENT LIQUID CRYSTAL FILMS ON FLEXIBLE SUBSTRATES

(71) Applicant: BASF SE, Ludwigshafen am Rhein (DE)

(72) Inventors: Michelle RICHERT, Basel (CH); Oliver SEEGER, Ludwigshafen (DE)

(73) Assignee: BASF SE, Ludwigshafen am Rhein (DE)

(21) Appl. No.: 17/049,514

(22) PCT Filed: Apr. 23, 2019
(86) PCT No.: PCT/EP2019/060261

§ 371 Date: Oct. 21, 2020

(30) Foreign Application Priority Data
Apr. 25, 2018 (EP) 18169205.4

(51) Int. Cl. C09D 11/54; C09D 11/102; C09D 11/107; C09D 11/101; B42D 25/364; B42D 25/373; B42D 25/328; B42D 25/369; B42D 25/382; B41M 3/14

(52) U.S. Cl. CPC C09D 11/54; C09D 11/102; C09D 11/107; C09D 11/101; B42D 25/364; B42D 25/351; B42D 25/328; B42D 25/369; B42D 25/382; B41M 3/148; B42D 25/373

(57) ABSTRACT

A process for producing strongly adherent liquid crystal films on flexible substrates, security elements, obtainable by the process and security documents, including the security elements, may involve coating a flexible substrate first with a primer layer and then with a liquid crystal film the adherence of the liquid crystal film to the substrate is improved while keeping the optical performance of the liquid crystal film in an acceptable range.

The present invention relates to a process for the production of strongly adherent liquid crystal films on flexible substrates, security elements, obtainable by the process and security documents, comprising the security elements. By coating a flexible substrate first with a primer layer and then with a liquid crystal film the adherence of the liquid crystal film to the substrate is improved while keeping the optical performance of the liquid crystal film in an acceptable range.

WO2011/082969 describes liquid-crystalline mixtures, and also oligomers or polymers which are obtainable by oligomerizing or polymerizing the liquid-crystalline mixtures, a process for printing or coating substrates by applying and then polymerizing the inventive liquid-crystalline mixtures and the use of the inventive liquid-crystalline mixtures or of the inventive oligomers or polymers for production of optical or electrooptical components.

WO2011/132137 relates to a process for producing polymerized films with line texture or fingerprint texture or for producing substrates coated with polymerized films with line texture or fingerprint texture, to polymerized films, obtainable by this process, to pigments obtainable by comminuting such films, to the use of such films, substrates or pigments as or in optical filter(s), polarizers, decorative media, forgeryproof markers, reflective media or for focusing light (in solar cells), to the use of such films as an antibacterial coating, to a forgeryproof marker which comprises such a film, and to a process for detecting forgeryproof markings.

WO2005/05573 relates to a film comprising polymerised liquid crystal (LC) material with improved adhesion to a substrate. The LC material comprises one or more polymerisable mesogenic compounds and one or more polymerisable adhesion promoters. Preferred adhesion promoters are 2-hydroxyethyl acrylate (HEA) or 2-hydroxyethyl methacrylate (HEA).

GB2398077A1 relates to a film comprising polymerised liquid crystal (LC) material, characterized in that it Is obtainable from a polymerisable material comprising not more than 7 percent by weight of compounds having two or more polymerisable groups. Using a polymerisable LC material comprising a low percentage of di- or multifunctional compounds leads to an LC polymer film with low degree of crosslinking with better adherence to plastic substrates.

EP1135219B1 relates to a process for the production of strongly adherent coatings on an inorganic or organic substrate that comprises

in a first step a) subjecting the inorganic or organic substrate to the action of a low-temperature plasma discharge, a corona discharge, high-energy UV radiation or electron radiation, then discontinuing the radiation or discharge;

in a further step b) under vacuum or at normal pressure, applying one or more photoinitiators containing at least one ethylenically unsaturated group to the inorganic or organic substrate, and allowing reaction with the free-radical sites formed there; and

c1) coating the substrate so precoated with photoinitiator with a composition comprising at least one ethylenically unsaturated monomer or oligomer, and curing the coating by means of UV/VIS radiation, or

c2) depositing a metal, semi-metal oxide or metal oxide from the gaseous phase, in the presence of UV light, on the substrate so precoated with photoinitiator.

WO03064061 relates to a process for the production of a strongly adherent coating on an inorganic or organic substrate, wherein a) a low-temperature plasma treatment, a corona discharge treatment or a flame treatment is carried out on the inorganic or organic substrate, b) one or more photoinitiators or mixtures of photoinitiators with monomers or/and oligomers, containing at least one ethylenically unsaturated group, or solutions, suspensions or emulsions of the afore-mentioned substances, are applied at normal pressure to the inorganic or organic substrate, and c) using suitable methods those afore-mentioned substances are optionally dried and/or are irradiated with electromagnetic waves.

WO06/067061 relates to a process for the production of strongly adherent coatings on an inorganic or organic substrate, wherein in a first step a) a low-temperature plasma, a corona discharge or a flame is caused to act on the inorganic or organic substrate, in a second step b) one or more defined photoinitiators or mixtures of defined photoinitiators with monomers, containing at least one ethylenically unsaturated group, or solutions, suspensions or emulsions of the afore-mentioned substances, are applied, preferably at normal pressure, to the inorganic or organic substrate, in a third step c) using suitable methods those afore-mentioned substances are dried and/or irradiated with electromagnetic waves and, optionally, in a fourth step d) on the substrate so pretreated is applied a further coating.

WO2013178523 (U.S. Pat. No. 9,718,974) relates to low-viscosity formulations of radiation-curable compounds, methods for the production thereof, the use thereof, and inks, printing inks, and printing varnishes containing said compound formulations.

The use of intermediate layers, such as adhesion layers, can negatively influence the optical performance of the liquid crystal film.

It has now been found, surprisingly, that by coating a flexible substrate first with a primer layer and then with a liquid crystal film the adherence of the liquid crystal film to the substrate is improved while simultaneously keeping the optical performance of the liquid crystal film in an acceptable range.

Accordingly, the present application relates to a process for the production of strongly adherent liquid crystal films on flexible substrates comprising

a) optionally exposing the flexible substrate to a corona discharge or a plasma discharge treatment;

b) applying a primer composition on the substrate, which comprises

b1) at least one polyurethane (A) comprising as synthesis components

(b1a) at least one organic aliphatic, aromatic or cycloaliphatic diisocyanate or polyisocyanate having a functionality of more than 2,

(b1b) at least one compound having in each case at least one isocyanate-reactive group and at least one radically polymerizable unsaturated group,

(b1c) at least one photoinitiator having at least one isocyanate-reactive group,

b2) at least one polyfunctional polymerizable compound (B),

b3) a solvent, or a mixture of solvents,

c) evaporating the solvent by applying IR-radiation and/or thermal drying,

d) curing the primer layer by means of UV/VIS radiation or electron beam,

e) optionally exposing the primered substrate to a corona discharge or a plasma discharge treatment,

f) applying a liquid crystal composition onto the primer coating,

g) evaporating the solvent by applying IR-radiation and/or thermal drying, and

h) curing the liquid crystal film by means of UV/VIS radiation or electron beam.

When measuring the transmission spectrum of the liquid crystal film on the PET film with primer and without primer the difference of the transmission minimum of the liquid crystal film on the PET film with primer and without primer is, in general, less than 20 nm. The transmission minimum represents the wavelength at the halfwidth of the transmission band at 80% transmission.

The liquid crystal films obtained by the process of the present invention have peelforces >20 N/m.

The term “liquid-crystalline” is used in the context of the present invention both for nematic and for cholesteric phases, unless otherwise evident from the particular context.

As materials for the flexible substrate, explicit mention should be made here of polyethylene terephthalate, polyethylene naphthalate, polyvinyl butyral, polyvinyl chloride, flexible polyvinyl chloride, polymethyl methacrylate, poly(ethylene-co-vinyl acetate), polycarbonate, cellulose triacetate, polyether sulfone, polyester, polyamide, polyolefins, such as, for example, polypropylene, and acrylic resins. Among these, polyethylene terephthalate, polyvinyl butyral, polyvinyl chloride, flexible polyvinyl chloride and polymethyl methacrylate are preferred.

The flexible substrate is preferably biaxially oriented.

The flexible substrate is preferably selected from a biaxially oriented polyethylene terephthalate (BOPET) film, or a biaxially oriented polypropylene (BOPP) film.

Process steps a) and e) are optional. In a preferred embodiment of the present invention the process comprises step a), while step e) is omitted. In another preferred embodiment of the present invention the process does not comprise step a) and e).

The principles of plasma production and maintenance are described, for example, in H. J. Jacobasch et al. in Farbe+Lack 99(7), 602-607 (1993) for low-temperature plasmas under vacuum conditions and by J. Friedrich et al. in Surf. Coat. Technol. 59, 371-6(1993) for plasmas ranging from in vacuo up to normal pressure conditions, the low-temperature plasma changing into a corona discharge.

Process steps a) and e) process can also be carried out under corona discharge conditions. Corona discharges are produced under normal pressure conditions, the ionised gas used being most frequently air. In principle, however, other gases and mixtures are also possible, as described, for example, in COATING Vol. 2001, No. 12, 426, (2001).

When a corona discharge is used, air, CO₂ and/or nitrogen are preferably used as the gas. It is especially preferred to use air, H₂, CO₂, He, Ar, Kr, Xe, N₂, O₂ or H₂O singly or in the form of a mixture.

The plasma treatment of the flexible substrate preferably takes place for from 1 ms to 300 s, especially from 10 ms to 200 s.

After the plasma-, or corona-treatment the primer composition is applied on the flexible substrate in process step b). In principle, it is advantageous to apply the primer composition as quickly as possible after the plasma- or corona-treatment.

The primer composition can be applied in process step b) by means of customary processes, for example by means of processes selected from slot die-, knive-, reverse roll-, metering rod coating, gravure-, flexo-, screen-, or ink jet printing.

In process step c) the evaporating of the solvent is done by applying infrared radiation (IR radiation), and/or thermal drying, for example, by means of hot air, a hot plate.

The evaporating of the solvent is affected preferably at elevated temperature, i.e. by heating, optionally under reduced pressure. It is preferred to carry out process step (c) at a temperature of from 40 to 140° C., more preferably from 60 to 120° C. The thermal energy can originate both from an external heat source as well as from the UV light source, for example a UV lamp. Preferably the thermal energy originates at least partly from a heat source different from the UV light source, for example from an oven or a heating plate.

Radiation curing in process steps d) and h) takes place with high-energy light, such as, for example, UV/VIS radiation, or electron beams. Radiation curing may also take place at relatively high temperatures.

Examples of suitable radiation sources for the radiation cure are low-pressure mercury lamps, medium-pressure mercury lamps with high-pressure lamps, and fluorescent tubes, pulsed lamps, metal halide lamps, or excimer lamps and also UV LEDs. The radiation cure is accomplished by exposure to high-energy radiation, i.e., UV/VIS radiation, preferably light in the wavelength range of λ=200 to 700 nm, more preferably λ=200 to 500 nm, or by exposure to high-energy electrons (electron beams; 60 to 300 keV). Examples of radiation sources used include high-pressure mercury vapor lamps, lasers, pulsed lamps (flash light), halogen lamps, UV LEDs, or excimer lamps. The radiation dose normally sufficient for crosslinking in the case of UV curing is in the range from 30 to 3000 mJ/cm².

The liquid crystal composition is applied to the substrate and then polymerized.

The liquid crystal composition can be applied in process step f) by means of customary processes, for example by means of processes selected from airblade coating, knife coating, airknife coating, squeegee coating, impregnation coating, reverse roll coating, transfer roll coating, gravure coating, kiss coating, flow coating, spray coating, spin coating, or printing processes such as relief printing, gravure printing, intaglio printing, flexographic printing, offset printing, inkjet printing, letterpress printing, pad printing, heatseal printing or screenprinting processes.

The liquid crystal composition is preferably applied by slot die-, knive-, reverse roll-, metering rod coating, gravure-, flexo-, screen-, or ink jet printing.

Preference is given to applying the composition by knife coating, and especially with a spiral doctor blade (for example from Erichsen). The higher the solids content of the composition used in process step f), the lower the doctor blade size selected.

If this has not already been accomplished by the process of application in process step f), the composition applied in process step f) has to be aligned before the polymerization step. The alignment of the liquid-crystalline layer generally proceeds spontaneously during the applying operation; it can, however, also be affected in a downstream step. In this case, the alignment is affected by means of the known methods, for example the interaction of the liquid-crystal phase with alignment layers, the application of electrical or magnetic fields and the mechanical knife coating of the liquid-crystal layers. However, the alignment preferably proceeds spontaneously under the action of the shear forces which act in the course of application.

In process step g) the evaporating of the solvent is done by applying infrared radiation (IR radiation) and/or thermal drying, for example, by means of hot air, a hot plate.

The evaporating of the solvent is affected preferably at elevated temperature, i.e. by heating, optionally under reduced pressure. It is preferred to carry out process step (g) at a temperature of from 40 to 150° C., more preferably from 60 to 140° C. The thermal energy can originate both from an external heat source as well as from the UV light source, for example a UV lamp. Preferably the thermal energy originates at least partly from a heat source different from the UV light source, for example from an oven or a heating plate.

The primer composition used in process step b) is new, forms a further subject of the present application and comprises

b1) at least one polyurethane (A) comprising as synthesis components

(b1a) at least one organic aliphatic, aromatic or cycloaliphatic diisocyanate or polyisocyanate having a functionality of more than 2,

(b1 b) at least one compound having in each case at least one isocyanate-reactive group and at least one radically polymerizable unsaturated group,

(b1c) at least one photoinitiator having at least one isocyanate-reactive group,

b2) at least one polyfunctional polymerizable compound (B),

b3) a solvent, or a mixture of solvents,

The polyurethane (A) and its production is described in WO2013178523. Synthesizing a polyurethane (A) comprising as synthesis components

(b1a) at least one polyisocyanate containing allophanate groups and having an NCO functionality of at least 2, synthesized from aliphatic C4 to C20 alkylene diisocyanates,

(b1b) at least one compound having in each case at least one isocyanate-reactive group and at least one radically polymerizable unsaturated group,

(b1c) at least one photoinitiator having at least one isocyanate-reactive group, under anhydrous conditions, wherein the polyurethanes (A) are prepared in the presence of less than 1000 ppm by weight of a bismuth, zinc- and/or titanium-containing compound.

Component (b1a) comprises polyisocyanates which contain allophanate groups and have an NCO functionality of at least 2, preferably of 2 to 5, and more preferably of 2 to 4. The polyisocyanates (a) containing allophanate groups are synthesized from aliphatic Cₐ to C₂₀ alkylene diisocyanates, preferably from hexamethylene 1,6-diisocyanate.

In one particularly preferred embodiment the compound in question is a polyisocyanate which contains allophanate groups and has the formula

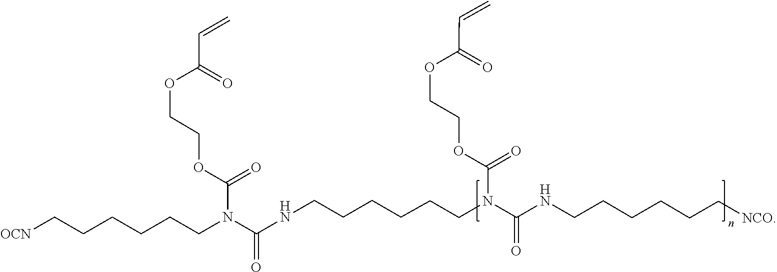

in which n is a positive number which is on average 1 up to 5, preferably from 1 to 3.

The compounds (b1 b) preferably have precisely one isocyanate-reactive group and 1 to 5, more preferably 1 to 4, and very preferably 1 to 3 radically polymerizable groups.

The components (b1 b) preferably have a molar weight of below 10 000 g/mol, more preferably below 5000 g/mol, very preferably below 4000 g/mol, and more particularly below 3000 g/mol. Special components (b) have a molar weight of below 1000 or even below 600 g/mol.

Preference is given to using 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol mono(meth)acrylate and di(meth)acrylate, trimethylolpropane mono(meth)acrylate and di(meth)acrylate, pentaerythritol mono(meth)acrylate, di(meth)acrylate, and tri(meth)acrylate, and also 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypro-pyl(meth)acrylamide, or 3-hydroxypropyl(meth)acrylamide. Particularly preferred are 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl (meth)acrylate, and also the monoacrylates of polyethylene glycol with a molar mass of 106 to 238. In one preferred embodiment, component (b) may also comprise technical mixtures from the acrylation of trimethylolpropane, pentaerythritol, ditrimethylolpropane or dipentaerythritol, or alkoxylated, preferably propoxylated and/or ethoxylated, more preferably ethoxylated, trimethylolpropane, pentaerythritol, ditrimethylolpropane or dipentaerythritol.

Component (b1c) is at least one photoinitiator having at least one isocyanate-reactive group, preferably at least one photoinitiator of the α-hydroxyacetophenone type or benzophenone type, in each case having at least one isocyanate-reactive group, and more preferably at least one photoinitiator of the α-hydroxyacetophenone type.

A photoinitiator for the purposes of this specification is a compound which can be cleaved into at least one radical by electromagnetic radiation, preferably by UV radiation, visible light or IR radiation, more preferably by UV radiation or visible light, and very preferably by UV radiation.

Component (b1c) may comprise one or more than one—for example, 1 to 3, preferably 1 to 2, and more preferably precisely one—group which is active as a photoinitiator, preferably α-hydroxyacetophenone group or benzophenone group, more preferably α-hydroxyacetophenone group. Moreover, component (c) may comprise one or more than one—for example, 1 to 4, preferably 1 to 3, more preferably 1 to 2 and very preferably precisely one—isocyanate-reactive group.

The groups which are active as photoinitiators may preferably be hydroxybenzophenones or hydroxyacetophenones, and more preferably hydroxyacetophenones.

Preferred components (b1c) are

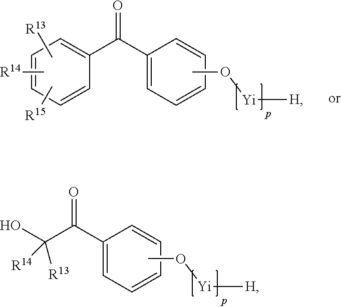

in which

R¹³, R¹⁴, and R¹⁵ each independently of one another are hydrogen, an alkyl group containing 1 to 4 carbon atoms or an alkyloxy group containing 1 to 4 carbon atoms,

p may be 0 (zero) or an integer from 1 to 10, and

Yᵢ for i=1 to p independently of one another may be selected from the group of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group of —CH₂—CH₂—O—, —CH₂—CH(CH₃)—O—, and —CH(CH₃)—CH₂—O—, and more preferably —CH₂—CH₂—O—, in which Ph is phenyl and Vin is vinyl.

The group —O— [—Yᵢ—]ₚ—H is preferably located in para-position to the carbonyl group.

The radicals R¹³, R¹⁴, and R¹⁵ independently of one another are preferably hydrogen or methyl, more preferably hydrogen.

Preferably p is 0 to 4, more preferably it is 1 to 3, and very preferably it is 1.

Preferred components (b1c) are 2-hydroxy-2-methyl-1-phenyl-propan-1-one, 1-hydroxycyclohexyl phenyl ketone, 1-[4-(2-hydroxyethoxy)phenyl]-2-hydroxy-2-methyl-1-propan-1-one, 2-hydroxy-1-{4-[4-(2-hydroxy-2-methylpropionyl)benzyl]phenyl}-2-methylpropan-1-one, 2-hydroxy-1-[4-[hydroxy[4-(2-hydroxy-2-methyl-propanoyl)phenyl]methyl]phenyl]-2-methyl-propan-1-one, [4-[3-(4-benzoylphenoxy)-2-hydroxypropoxy]phenyl]phenylmethanone, benzoin, benzoin isobutyl ether, benzoin tetrahydropyranyl ether, benzoin methyl ether, benzoin ethyl ether, benzoin butyl ether, benzoin isopropyl ether, 7H-benzoin methyl ether, 2-hydroxy-2,2-dimethylacetophenone, or 1-hydroxyacetophenone.

Particularly preferred are 1-[4-(2-hydroxyethoxy)phenyl]-2-hydroxy-2-methyl-1-propan-1-one, 2-hydroxy-1-{4-[4-(2-hydroxy-2-methylpropionyl)benzyl]phenyl}-2-methyl-propan-1-one, and 2-hydroxy-1-[4-[hydroxy-[4-(2-hydroxy-2-methylpropanoyl)phenyl]methyl]phenyl]-2-methylpropan-1-one; especially preferred is 1-[4-(2-hydroxyethoxy)phenyl]-2-hydroxy-2-methyl-1-propan-1-one.

The polyurethane (A) is preferably a compound of formula

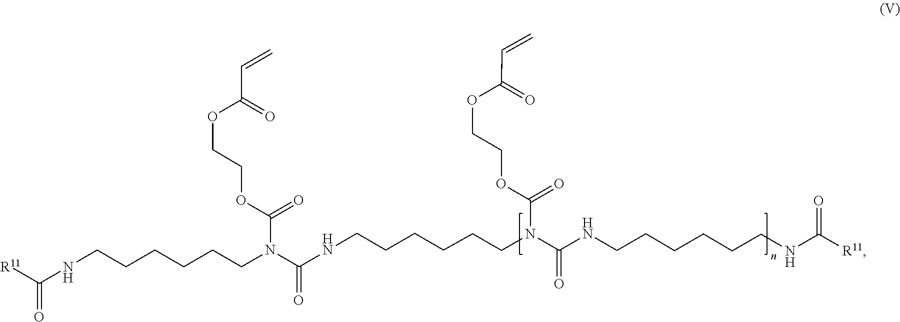

wherein n is a positive number which is on average 1 up to 5, preferably from 1 to 3, and R¹¹ is a group of formula

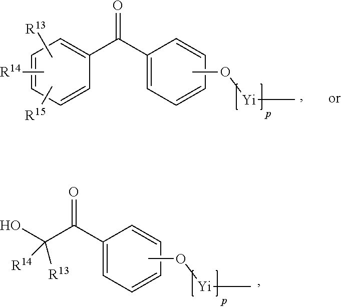

in which

R¹³, R¹⁴, and R¹⁵ each independently of one another are hydrogen, an alkyl group containing 1 to 4 carbon atoms or an alkyloxy group containing 1 to 4 carbon atoms,

p may be 0 (zero) or an integer from 1 to 10, and

Yᵢ for i=1 to p independently of one another may be selected from the group of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHPh-O—, and —CHPh-CH₂—O—, preferably from the group of —CH₂—CH₂—O—, —CH₂—CH(CH₃)—O—, and —CH(CH₃)—CH₂—O—, and more preferably —CH₂—CH₂—O—, in which Ph is phenyl and Vin is vinyl.

More preferred are compounds of formula (V), wherein n is 1, and R¹¹ is a group of formula

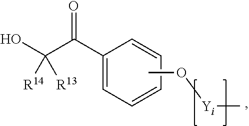

in which

R¹³ and R¹⁴ each independently of one another are an alkyl group containing 1 to 4 carbon atoms,

Yᵢ for is a group of —CH₂—CH₂—O—, —CH₂—CH(CH₃)—O—, and —CH(CH₃)—CH₂—O—, preferably —CH₂—CH₂—O—.

The polyfunctional polymerizable compounds (B) may contain two or more ethylenically unsaturated double bonds. They may be lower molecular weight (monomeric) or higher molecular weight (oligomeric).

Examples of polyfunctional polymerizable compounds (B) are ethylene glycol diacrylate, 1,6-hexanediol diacrylate, propylene glycol diacrylate, dipropylene glycol diacrylate, tripropylene glycol diacrylate, ditrimethylol tetracrylate, neopentyl glycol diacrylate, hexamethylene glycol diacrylate and bisphenol-A diacrylate, 4,4′-bis(2-acryloyloxyethoxy)diphenylpropane, trimethylolpropane triacrylate, pentaerythritol triacrylate, pentaerythritol tetraacrylate, vinyl acrylate, divinylbenzene, divinyl succinate, diallyl phthalate, triallyl phosphate, triallyl isocyanurate, tris(hydroxyethyl) isocyanurate triacrylate (Sartomer® 368; from Arkema) and tris(2-acryloylethyl) isocyanurate, ethyleneglycoldivinylether, diethyleneglycoldivinylether, triethylene glycoldivinylether, polyethyleneglycol-mono-(meth)acrylate, polyethyleneglycol-di-(meth)acrylate, and vinyl(meth)acrylat.

It is also possible to use polyester polyol acrylates, polyetherol acrylates and acrylic esters of alkoxylated polyols, for example triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol.

Examples of higher molecular weight (oligomeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition, it is also possible to use vinyl ether monomers and oligomers, and also maleate-terminated oligomers having polyester, polyurethane, polyether, polyvinyl ether and epoxide main chains. In particular, combinations of vinyl-ether-group-carrying oligomers and polymers, as described in WO 90/01512, are suitable.

Also suitable are, for example, esters of ethylenically unsaturated carboxylic acids and polyols.

Examples of unsaturated carboxylic acids are acrylic acid, methacrylic acid, crotonic acid, maleic acid, fumaric acid, itaconic acid, cinnamic acid and unsaturated fatty acids such as linolenic acid or oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)propane, and novolaks and resols.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols from 200-35000, preferably from 200 to 1500, polypropylene glycols having molecular weights from 200-35000, preferably from 200 to 1500, polytetrahydrofuranes having molecular weights from 200-50000, preferably from 200 to 2000, 1,3-cyclopentanediol, 1,2-, 1,3- or 1,4-cyclohexanediol, 1,4-dihydroxymethylcyclo-hexane, glycerol, tris(11-hydroxyethyl)amine, trimethylolethane, trimethylolpropane, pentaerythritol, dipentaerythritol and sorbitol.

The polyols may have been partially or fully esterified by one or by different unsaturated carboxylic acid(s), it being possible for the free hydroxyl groups in partial esters to have been modified, for example etherified, or esterified by other carboxylic acids.

Examples of esters are:

trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable are the amides of identical or different unsaturated carboxylic acids and 30 aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diamino-cyclohexane, isophoronediamine, phenylenediamine, bisphenylenediamine, di-ß-aminoethyl ether, diethylenetriamine, triethylenetetramine and di(ß-aminoethoxy)- and di(ß-aminopropoxy)-ethane. Examples of such unsaturated amides are: methylene bisacrylamide, 1,6-hexamethylene bisacrylamide, diethylenetriamine trismethacrylamide, bis(methacrylamidopropoxy)ethane, ß-methacryl-amidoethyl methacrylate and N-[(ß-hydroxyethoxy)ethyl]-acrylamide.

In the context of the present application the term (meth)acrylate includes both the acrylate and the methacrylate.

The polymerizable compound (B) is preferably selected from 1,2-propanediol diacrylate, 1,3-propanediol diacrylate, dipropylene glycol diacrylate, polyethylene glycol diacrylate, polyethylene glycol dimethacrylate, tripropylene glycol diacrylate, trimethylolpropane triacrylate, ditrimethylol tetracrylate, dipentaerythritol hexaacrylate, triacrylate of singly to vigintuply alkoxylated, more preferably singly to vigintuply ethoThe xylated trimethylolpropane, singly to vigintuply propoxylated glycerol or singly to vigintuply ethoxylated and/or propoxylated pentaerythritol.

Polyethylene glycol diacrylates and dimethacrylates having a molecular weight of from 200 to 1500, such as, for example, SARTOMER® 259 (polyethylene glycol (200) diacrylate), 344 (polyethylene glycol (400) diacrylate), 610 (polyethylene glycol (600) diacrylate), 603 (polyethylene glycol (400) dimethacrylate), 252 (polyethylene glycol (600) dimethacrylate) (commercially available by Arkema) are most preferred.

The weight ratio of polyurethane (A) to polymerisable compound (B) is within the range of 3:1 to 1:3.

Solvents b3) include, for example, C1-C₆-alcohols, for example methanol, ethanol, n-propanol, isopropanol, butanol, isobutanol, sec-butanol, tert-butanol, n-pentanol, n-hexanol, and isomers thereof, glycols, for example 1,2-ethylene glycol, 1,2- or 1,3-propylene glycol, 1,2-, 2,3- or 1,4-butylene glycol, di- or triethylene glycol or di- or tripropylene glycol, ethers, for example open-chain ethers such as methyl tert-butyl ether, 1,2-ethylene glycol monomethyl or dimethyl ether, 1,2-ethylene glycol monoethyl or diethyl ether, 3-methoxypropanol or 3-isopropoxypropanol, or cyclic ethers such as tetrahydrofuran or dioxane, open-chain ketones, for example acetone, methyl ethyl ketone, methyl isobutyl ketone or diacetone alcohol (4-hydroxy-4-methyl-2-pentanone), cyclic ketones such as cyclopentanone or cyclohexanone, C₁-C₅-alkyl esters, for example methyl acetate, ethyl acetate, propyl acetate, butyl acetate or amyl acetate, C₁-C₄-alkoxy-C₁-C₄-alkyl esters such as 1-methoxyprop-2-yl acetate, carboxamides such as dimethylformamide and dimethylacetamide, N-heterocycles such as N-methylpyrrolidone, aliphatic or aromatic hydrocarbons, for example pentane, hexane, heptane, octane, isooctane, petroleum ether, toluene, xylene, ethylbenzene, tetralin, decalin, dimethylnaphthalene, white spirit, Shellsol® or Solvesso®. As a matter of course, mixtures of these solvents are also useful for use in the inventive mixtures.

The solvent (b3)) is preferably selected from C₁-C₆alcohols, ether-C₁-C₆alcohols, such as, for example, 3-methoxypropanol, or 3-isopropoxypropanol, and mixtures thereof.

The proportion of the solvent is 90.0 to 99.5% by weight, especially 95.0 to 99.5% by weight, very especially 98.0 to 99.5% by weight, the proportion of compound (B) and the polyurethane (A) is 10 to 0.5% by weight, especially 5.0 to 0.5% by weight, very especially 2.0 to 0.5% by weight wherein the proportions of solvent, compound (B) and polyurethane (A) add up to 100% by weight.

The liquid crystal composition is preferably selected from
(a.1) a composition comprising at least one achiral nematic polymerizable monomer and at least one chiral polymerizable monomer;
(a.2) a composition comprising at least one cholesteric polymerizable monomer;
(a.3) a composition comprising at least one cholesteric crosslinkable polymer;
(a.4) a composition comprising at least one cholesteric polymer in a polymerizable diluent; and
(a.5) a mixture of at least two of these compositions;

Preferably, at least one achiral nematic polymerizable monomer of the composition (a.1) is polyfunctionally and especially difunctionally polymerizable. Such monomers are, for example, described in WO05049703, WO, 97/00600, WO 2006/120220, WO0055110 and G. Challa et al., Makromol. Chem. 190 (1989) 3201-3215).

Preferred achiral nematic difunctionally polymerizable monomers correspond to the general formula I:

Z¹—(Y¹-A¹)ᵥ-Y²-M-Y³-(A²-Y⁴)_{w}—Z² (I), in which
Z¹, Z² are identical or different reactive groups through which polymerization can be effected, or radicals which comprise such reactive groups, the reactive groups preferably being selected from C═C double bonds, C≡C triple bonds, oxirane, thiirane, azirane, cyanate, thiocyanate, isocyanate, carboxylic acid, hydroxyl or amino groups, and preferably from C═C double bonds (these may, for example, be —CH═CH₂ or —C(CH₃)═CH₂ or else —CH═CH(CH₃), preference being given to the first two mentioned);
Y¹, Y², Y³, Y⁴ are each independently a chemical bond, —O—, —S—, —CO—O—, —O—CO—, —O—CO—O—, —CO—S—, —S—CO—, —CO—N(R^{a})—, —N(R^{a})—CO—, —N(R^{a})—CO—O—, —O—CO—N(R^{a})—, —N(R^{a})—CO—N(R^{a})—, —CH₂—O—, —O—CH₂—, preferably —CO—O—, —O—CO— or —O—CO—O—,
   where R^{a} is hydrogen or C₁-C₄-alkyl;
A¹, A² are identical or different spacers which are selected from linear C₂-C₃₀alkylene groups, preferably C₂-C₁₂-alkylene groups, which may be interrupted by oxygen, sulfur and/or optionally monosubstituted nitrogen, where these interrupting groups must not be adjacent; where suitable amine substituents comprise C₁-C₄-alkyl groups, where the alkylene chains may be substituted by fluorine, chlorine, bromine, cyano, methyl or ethyl;
and where A¹ and A² are more preferably —(CH₂)ₙ₁— where n1=from 2 to 6;
v and w are each independently 0, 1 or 2;
M is a mesogenic group, preferably a mesogenic group of the general formula II:

(T¹-Y⁵)_{y}-T² (II), in which
each T¹ is independently a divalent alicyclic, saturated or partially unsaturated heterocyclic, aromatic or heteroaromatic radical;
T² is independently as defined for T¹;
Y⁵ represents identical or different bridging members —CO—O—, —O—CO—, —CH₂—O—, —O—CH₂—, —CO—S—, —S—CO—, —CH₂—S—, —S—CH₂, —CH═N—, —N═CH—, —CH═N—N═CH—, —CH═CH—, —C(CH₃)═CH₂, —CH═CH(CH₃)— or a direct bond and is preferably —CO—O— or —O—CO—, and
y is an integer from 0 to 3, preferably 0, 1 or 2, in particular 1 or 2 and especially 2.
T² is preferably an aromatic radical and more preferably a phenyl radical. T² is especially a radical of the formula

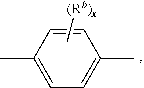

in which
R^{b} is fluorine, chlorine, bromine, C₁-C₂₀-alkyl, C₁-C₁₀-alkylcarbonyl, C₁-C₁₀-alkylcarbonyloxy, C₁-C₁₀-alkoxycarbonyl, hydroxyl, nitro, CHO or CN, preferably chlorine, bromine, C₁-C₄-alkyl or C₁-C₄-alkoxycarbonyl, and especially methyl or methoxycarbonyl; and
x is 0, 1, 2, 3 or 4, preferably 0, 1 or 2, more preferably 0 or 1 and especially 1.

Each T¹ is independently preferably an aromatic radical, more preferably phenyl or naphthyl and especially 1,4-bonded phenyl or 2,6-bonded naphthyl. Y⁵ is preferably —CO—O— or —O—CO—. y is preferably 2.

Particularly preferred mesogenic groups M have the following structures:

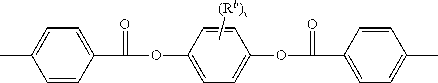

in which R^{b} and x each have one of the general or preferred definitions specified above, where R^{b} is especially methyl and x is 1, or

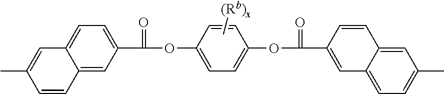

in which R^{b} and x have one of the general or preferred definitions specified above, where R^{b} is especially methoxycarbonyl and x is 1.

In a particularly preferred embodiment, the achiral nematic difunctionally polymerizable monomers are selected from compounds of the following formulae I.a and I.b

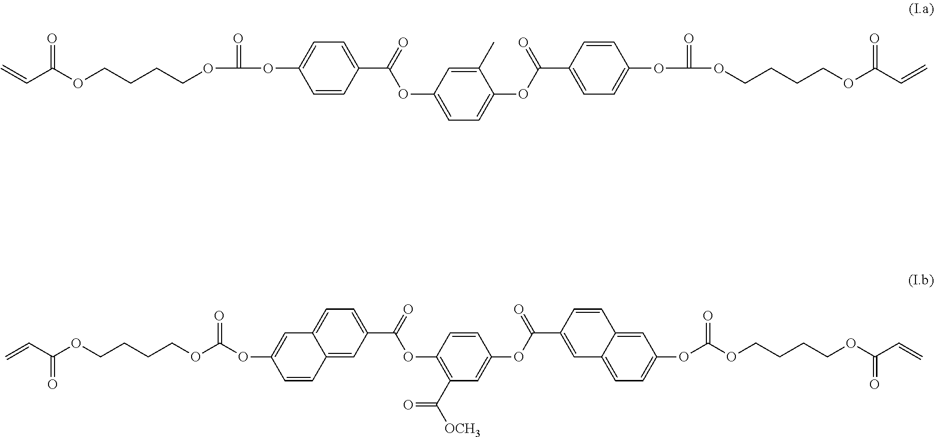

and mixtures thereof.

However, the composition (a.1) may also comprise a monofunctionally polymerizable achiral nematic monomer. This preferably has the general formula (IIIa) and/or (IIIb):

A³-Y²-M-Y³-(A²-Y⁴)_{w}—Z² (IIIa)

Z¹—(Y¹-A¹)ᵥ-Y²-M-Y³-A³ (IIIb), in which

Z¹, A¹, A², Y₁, Y², Y³, Y⁴, v, w and M are each independently as defined generally or preferably for formula (I); and
A³ is a linear C₁-C₃₀alkyl group, preferably a linear C₁-C₁₂-alkyl group, which may be interrupted by oxygen, sulfur and/or optionally monosubstituted nitrogen, where these interrupting groups must not be adjacent; where suitable amine substituents comprise C₁-C₄-alkyl groups, where the alkyl group may be substituted by fluorine, chlorine, bromine, cyano, methyl or ethyl, or is CN or —N═C═S—.

A³ is preferably linear C₂-C₈-alkyl or CN and especially linear C₄-C₈-alkyl or CN. Y¹, Y², Y³, Y⁴ and Y⁵ are each independently preferably —O—CO—, —CO—O—, —O—CO—O— or a C—C-triple bond. Z¹ is preferably a C—C-double bond (preferably —CH═CH₂ or —C(CH₃)═CH₂). M is preferably a mesogenic group of the general formula II. T¹ and T² are preferably each independently an aromatic group, more preferably phenyl or naphthyl which may bear 0, 1, 2, 3 or 4 R^{b} radicals, where R^{b} has one of the general or preferred definitions specified above, especially 1,4-bonded phenyl or 2,6-bonded naphthyl which may bear 0, 1, 2, 3 or 4 R^{b} radicals, where R^{b} has one of the general or preferred definitions specified above, and especially unsubstituted 1,4-bonded phenyl or unsubstituted 2,6-bonded naphthyl. y is preferably 0 or 1.

Particularly preferred monofunctionally polymerizable achiral nematic monomers are selected from the following structures:

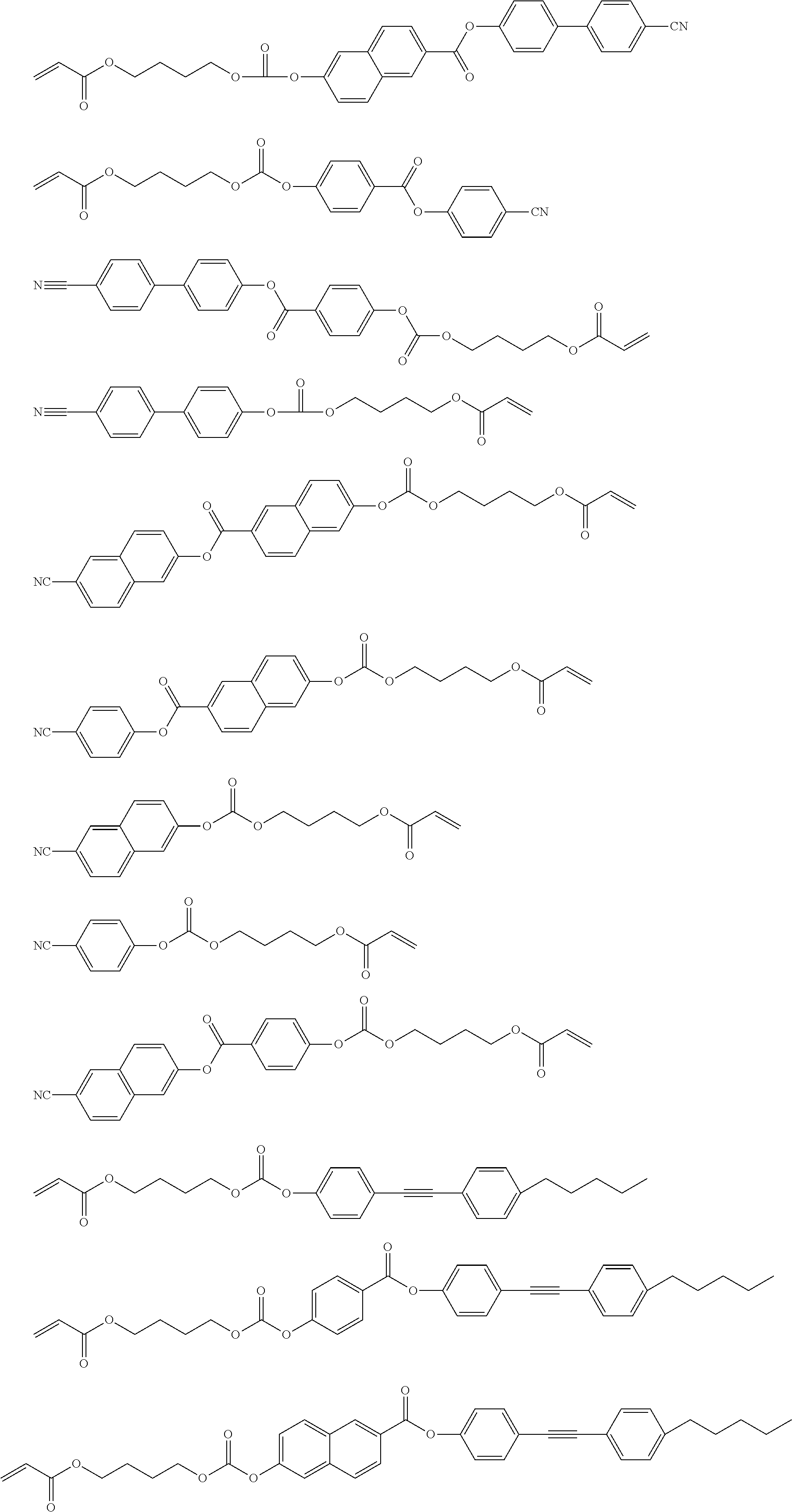

The at least one achiral nematic polymerizable monomer of the composition (a.1) comprises preferably
(i) at least one difunctionally polymerizable achiral nematic monomer of the formula (I), preferably one or two difunctionally polymerizable achiral nematic monomers of the formula (I); and
(ii) optionally at least one monofunctionally polymerizable achiral nematic monomer of the formula (IIIa) and/or (IIIb).

When the composition (a.1) comprises one or more monofunctionally polymerizable monomers, they are preferably present in the composition in a total amount of not more than 50% by weight, more preferably of not more than 25% by weight, even more preferably of not more than 15% by weight based on the total weight of the poly- and monofunctionally polymerizable achiral nematic monomers.

In a specific embodiment, the composition (a.1) does not comprise any monofunctionally polymerizable achiral nematic monomers, but rather only at least one, preferably one or two, polyfunctionally, especially difunctionally, polymerizable achiral nematic monomer(s).

The chiral polymerizable monomer of the composition (a.1) are, for example, described in EP1273585, WO0294805, EP0750029 and corresponds preferably to the formula IV:

[(Z¹—Y¹)ₒ-A⁴-Y²-M-Y³]ₙ₂X[Y³-M-Y²-A⁵-(Y¹—Z¹)ₚ]ₘ₁ (IV), where
Z¹, Y¹, Y², Y³ and M each have one of the general or preferred definitions specified above for formula (I)
o, p are each 0 or 1, where o and p must not both be 0,
A⁴ and A⁵ are the same or different; and
A⁴ is as defined for A¹ when o=1; or,
   when o=0, is a linear C₁-C₃₀-alkyl group, preferably C₁-C₁₂-alkyl group, which may be interrupted by oxygen, sulfur and/or optionally monosubstituted nitrogen, where these interrupting groups must not be adjacent; where suitable amine substituents comprise C₁-C₄-alkyl groups, where the alkyl groups may be substituted by fluorine, chlorine, bromine, cyano, methyl or ethyl, and where A⁴ more preferably represents CH₃(CH₂)_{I} groups where I=from 1 to 7;
A⁵ is as defined for A¹ when p=1; or,
   when p=0, is a linear C₁-C₃₀-alkyl group, preferably C₁-C₁₂-alkyl group, which may be interrupted by oxygen, sulfur and/or optionally monosubstituted nitrogen, where these interrupting groups must not be adjacent; where suitable amine substituents comprise C₁-C₄-alkyl groups, where the alkyl groups may be substituted by fluorine, chlorine, bromine, cyano, methyl or ethyl, and where A⁵ more preferably represents CH₃(CH₂)_{I} groups where I=from 1 to 7;
n2, m1 are each 0, 1 or 2, where the sum of n2+m1 is 1 or 2, preferably 2; and
X is a chiral radical.

The mesogenic M groups preferably have the formula II

(T¹-Y⁵)_{y}-T² (II)

in which T¹, T² and Y⁵ each have one of the general or preferred definitions specified above. y has one of the general definitions specified above, but is preferably 0 or 1.
T² is preferably an aromatic radical and more preferably a phenyl radical. T² is especially a radical of the formula

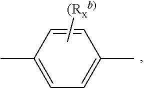

in which
R^{b} is fluorine, chlorine, bromine, C₁-C₂₀-alkyl, C₁-C₁₀-alkylcarbonyl, alkylcarbonyloxy, C₁-C₁₀-alkoxycarbonyl, hydroxyl, nitro, CHO or CN, preferably chlorine, bromine, C₁-C₄-alkyl or C₁-C₄-alkoxycarbonyl, and especially methyl or methoxycarbonyl; and
x is 0, 1, 2, 3 or 4, preferably 0, 1 or 2, more preferably 0 or 1 and especially 0.

Each T¹ independently is preferably an aromatic radical, more preferably phenyl or naphthyl, even more preferably 1,4-bonded phenyl or 2,6-bonded naphthyl and especially unsubstituted 1,4-bonded phenyl or unsubstituted 2,6-bonded naphthyl.

Y⁵ is preferably —CO—O— or —O—CO—. y is preferably 0 or 1.

Among the chiral X radicals of the compounds of the general formula IV, for reasons including easier availability, preference is given especially to those which derive from sugars, dinaphthyl or diphenyl derivates and optically active glycols, alcohols or amino acids. Among the sugars, especially pentoses and hexoses and derivatives derived therefrom should be mentioned.

Examples of X radicals are the following structures, where the terminal dashes are in each case the free valences.

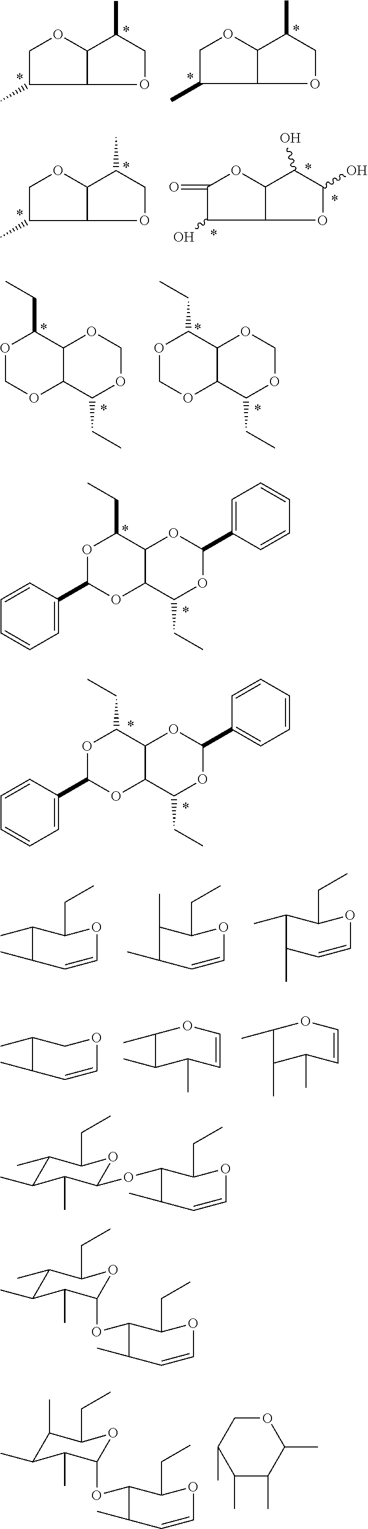

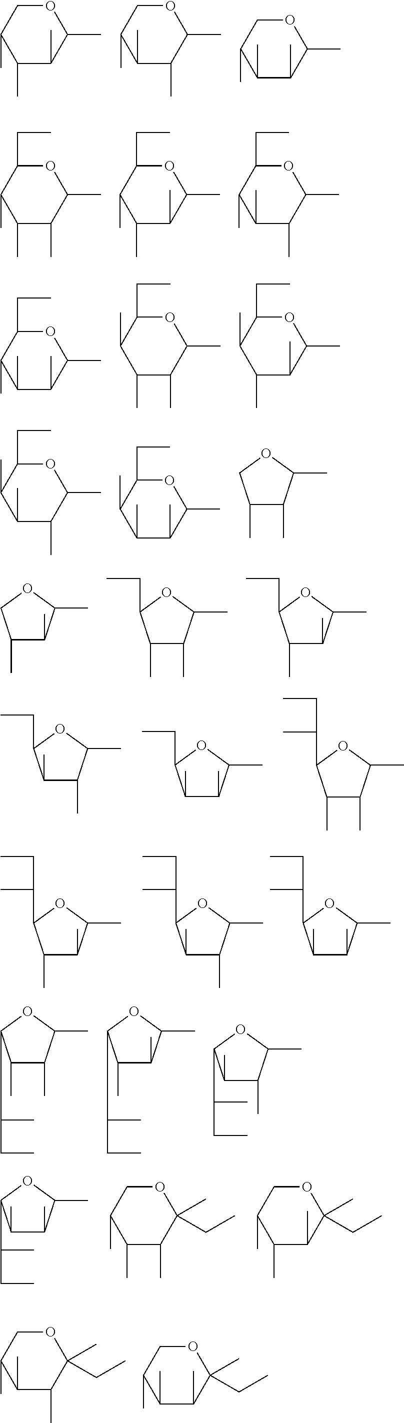

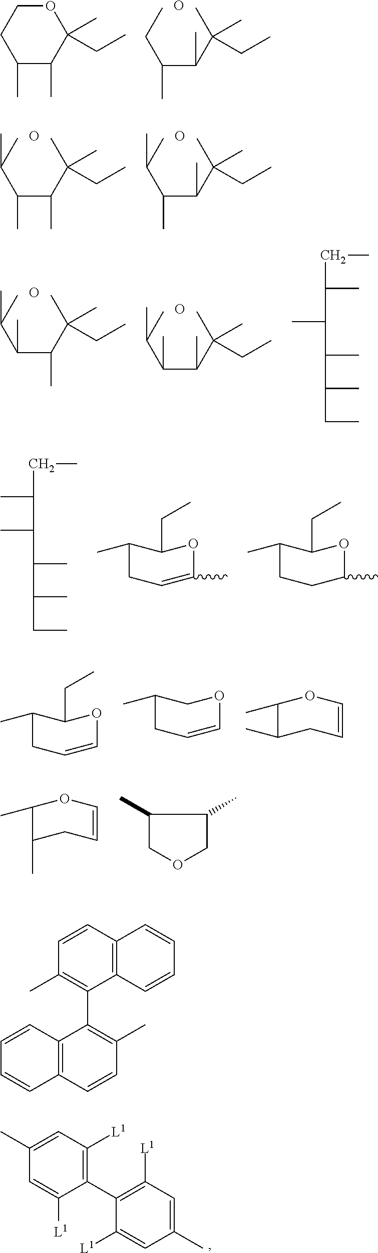

where
L¹ is C₁-C₄-alkyl, C₁-C₄-alkoxy, halogen, COORS, COOR^{c} or NHCOR^{c}, and R^{c} is C₁-C₄-alkyl or hydrogen.

Particular preference is given to

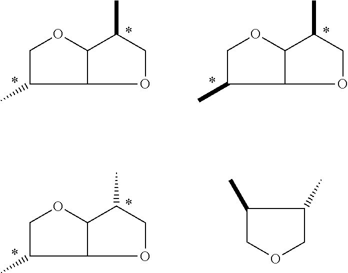

Additionally suitable are also chiral groups which have the following structures:

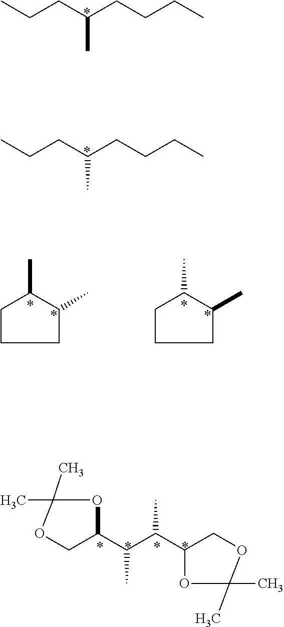

In a particularly preferred embodiment, the chiral polymerizable monomer is selected from the following structural formulae

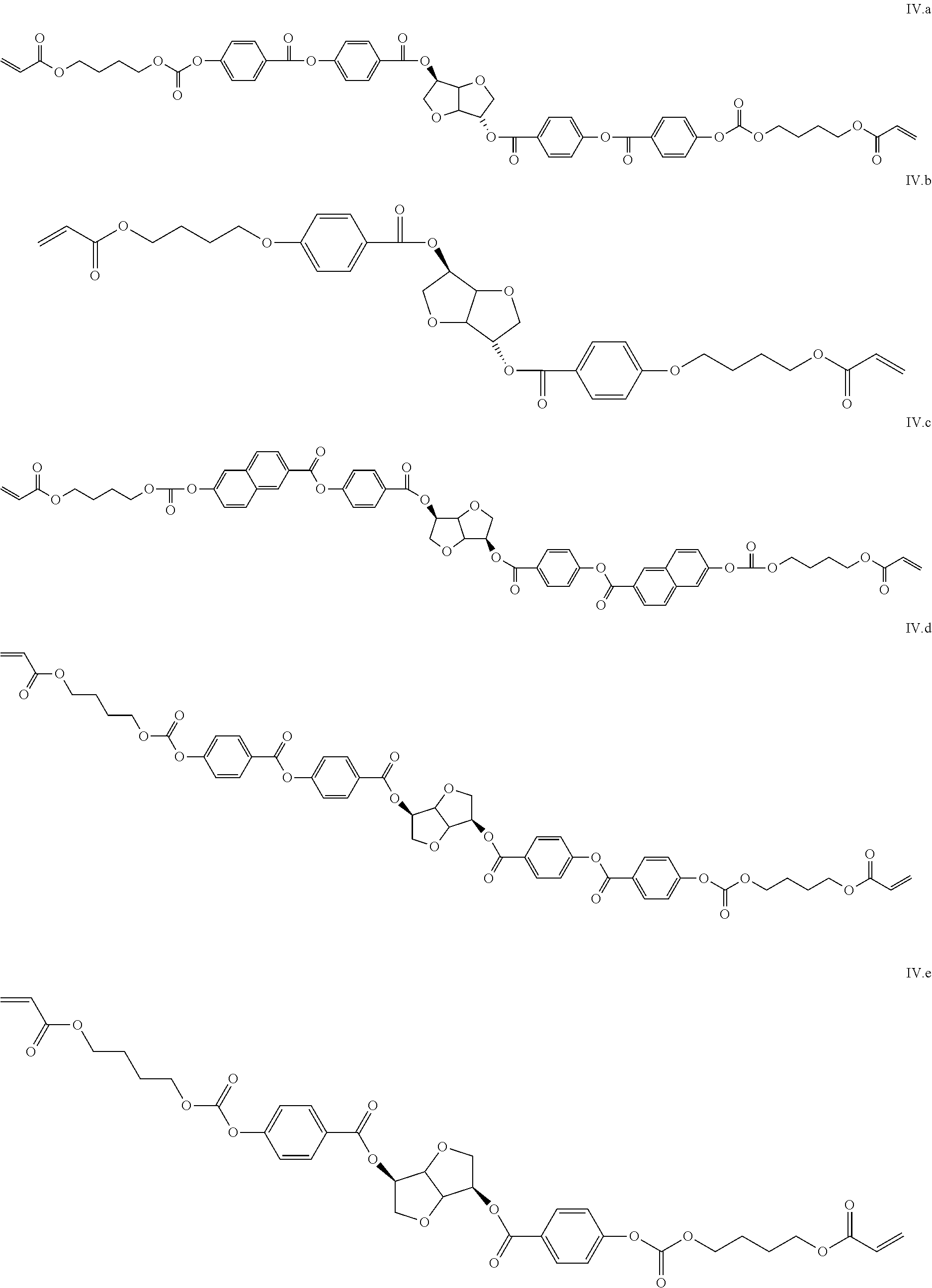

Among these, preference is given to the compounds of the formulae IV.a, IV.b and IV.c and particular preference to the compounds of the formulae IV.a and IV.c. Especially preferred is the compound of the formula IV.a.

Preferred monomers of group (a.2) are described in DE-A 19602848, which is hereby fully incorporated by reference. More particularly, the monomers comprise at least one cholesteric polymerizable monomer of the formula XIII

(Z¹—Y¹-A¹-Y²-M¹-Y³)₂X (XIII).

The variables are as defined for the monomers of group (a.1). The preferred embodiments apply correspondingly.

Alternatively, the layer (a) may comprise at least one cholesterically crosslinkable polymer of the composition (a.3).

Preferred polymers of group (a.3) are described in WO 2008/012292 and in the literature cited therein, which is hereby fully incorporated by reference.

Alternatively, the layer (a) may also comprise a cholesteric polymer in a polymerizable diluent (composition (a.4)).

Preferred polymers and diluents of group (a.3) are described in WO 2008/012292 and in the literature cited therein, which is hereby fully incorporated by reference. Preferred polymers of group (a.4) are, for example, crosslinkable cholesteric copolyisocyanates as described in U.S. Pat. No. 08,834,745, which is hereby fully incorporated by reference.

The layer (a) preferably comprises the composition (a.1) in hardened form. With regard to preferred configurations of the composition (a.1), reference is made to the statements above. The composition (a.1) preferably comprises the nematic polymerizable monomer in an amount of from 80 to 99.5% by weight and the chiral polymerizable monomer in an amount of from 0.5 to 20% by weight, based in each case on the total weight of the composition (a.1). The proportion of chiral-nematic monomer determines the spectral region in which the composition (a.1) reflects after alignment and hardening. The desired reflection range can be established with the aid of simple preliminary tests as a function of the individual nematic and chiral components and their particular concentrations. The composition (a.1) more preferably comprises the nematic polymerizable monomer(s) in an amount of from 85 to 99.5% by weight, more preferably from 85 to 99% by weight and especially from 90 to 98% by weight, and the chiral polymerizable monomer in an amount of from 0.5 to 15% by weight, more preferably from 1 to 15% by weight and especially from 2 to 10% by weight, based in each case on the total weight of the nematic polymerizable monomers and of the chiral polymerizable monomers in the composition (a.1). With regard to suitable and preferred ratios for monomers used with preference, reference is made to the above remarks.

If desired, the compositions (a.1), (a.2), (a.3), (a.4) and (a.5), as well as the components already mentioned which are responsible for the reflection behavior, may comprise further mixture constituents which are preferably selected from
at least one component C which is in turn selected from

(C.1) photoinitiators;

(C.2) reactive diluents which comprise photopolymerizable groups;

(C.3) solvents;

(C.4) defoamers and deaerating agents;

(C.5) lubricants and leveling agents;

(C.6) thermally curing and/or radiation-curing auxiliaries;

(C.7) substrate wetting auxiliaries;

(C.8) wetting and dispersing auxiliaries;

(C.9) hydrophobizing agents;

(C.10) in-can stabilizers; and

(C.11) auxiliaries for improving scratch resistance;
at least one component D which is in turn selected from

(D.1) dyes; and

(D.2) pigments;
at least one component E which is in turn selected from light, heat and oxidation stabilizers; and
at least one component F which is in turn selected from IR-absorbing compounds.

When the compositions (a.1), (a.2), (a.3), (a.4) or (a.5) are to be polymerized photochemically, they may comprise commercial photoinitiators. For curing by electron beams, they are not required. Suitable photoinitiators are, for example, isobutyl benzoin ether, 2,4,6-trimethylbenzoyldiphenylphosphine oxide, 1-hydroxycyclohexyl phenyl ketone, 2-benzyl-2-dimethylamino-1-(4-morpholinophenyl)furan-1-one, mixtures of benzophenone and 1-hydroxycyclohexyl phenyl ketone, 2,2-dimethoxy-2-phenylacetophenone, perfluorinated diphenyltitanocenes, 2-methyl-1-(4-[methylthio]phenyl)-2-(4-morpholinyl)-1-propanone, 2-hydroxy-2-methyl-1-phenylpropan-1-one, 4-(2-hydroxyethoxy)phenyl 2-hydroxy-2-propyl ketone, 2,2-diethoxyacetophenone, 4-benzoyl-4′-methyldiphenyl sulfide, ethyl 4-(dimethylamino)benzoate, mixtures of 2-isopropylthioxanthone and 4-isopropylthioxanthone, 2-(dimethylamino)ethyl benzoate, d,l-camphorquinone, ethyl-d,l-camphorquinone, mixtures of benzophenone and 4-methylbenzophenone, benzophenone, 4,4′-bis(dimethylamine)benzophenone, (η⁵-cyclopentadienyl) (η⁶-isopropylphenypiron(II) hexafluorophosphate, triphenylsulfonium hexafluorophosphate or mixtures of triphenylsulfonium salts, and butanediol diacrylate, dipropylene glycol diacrylate, hexanediol diacrylate, 4-(1,1-dimethylethyl)cyclohexyl acrylate, trimethylolpropane triacrylate and tripropylene glycol diacrylate.

Suitable commercial photoinitiators (C.1) are, for example, those which are commercially available under the brand names Lucirin®, Irgacure® and Darocure®. Preference is given to using the initiators Lucirin® TPO, Lucirin® TPO-L, Irgacure® Oxe 01, Irgacure® Oxe 02, Irgacure® 1300, Irgacure® 184, Irgacure® 369, Irgacure® 907 or Darocure® 1173, and particular preference to using the initiators Lucirin® TPO, Lucirin® TPO-L, Irgacure® Oxe 01, Irgacure® Oxe 02, Irgacure® 1300 or Irgacure® 907.

The photoinitiators are used typically in a proportion of from about 0.1 to 5.0% by weight based on the total weight of the liquid-crystalline mixture. Especially when the hardening is performed under inert gas atmosphere, it is possible to use significantly smaller amounts of photoinitiators.

In this case, the photoinitiators are used in a proportion of from about 0.1 to 1.0% by weight, preferably from 0.2 to 0.6% by weight, based on the total weight of the liquid-crystalline mixture.

Reactive diluents (C.2) are used, for example, as polymerizable diluents in component (a.4); they are then necessarily part of the inventive mixture.

The reactive diluents used are not only those substances which are referred to as reactive diluents in the actual sense (group C.2.1), but also auxiliary compounds which comprise one or more complementary reactive units, for example hydroxyl or amino groups, through which a reaction with the polymerizable units of the liquid-crystalline compounds can be effected (group C.2.2).

The substances of group (C.2.1) which are typically capable of photopolymerization include, for example, mono-, bi- or polyfunctional compounds having at least one olefinic double bond. Examples thereof are vinyl esters of carboxylic acids, for example of lauric acid, myristic acid, palmitic acid or stearic acid, or of dicarboxylic acids, for example of succinic acid and adipic acid, allyl or vinyl ethers or methacrylic or acrylic esters of monofunctional alcohols, for example of lauryl alcohol, myristyl alcohol, palmityl alcohol or stearyl alcohol, or diallyl or divinyl ethers of bifunctional alcohols, for example of ethylene glycol and of butane-1,4-diol.

Further useful examples are methacrylic or acrylic esters of polyfunctional alcohols, especially those which, as well as the hydroxyl groups, comprise no further functional groups or, at most, ether groups. Examples of such alcohols are, for example, bifunctional alcohols such as ethylene glycol, propylene glycol, and their more highly condensed representatives, for example diethylene glycol, triethylene glycol, dipropylene glycol, tripropylene glycol, etc., butanediol, pentanediol, hexanediol, neopentyl glycol, alkoxylated phenolic compounds such as ethoxylated or propoxylated bisphenols, cyclohexanedimethanol, trifunctional and higher-functionality alcohols such as glycerol, trimethylolpropane, butanetriol, trimethylolethane, pentaerythritol, ditrimethylolpropane, dipentaerythritol, sorbitol, mannitol and the corresponding alkoxylated, especially ethoxylated and propoxylated, alcohols.

Further useful reactive diluents of group (C.2.1) are polyester (meth)acrylate, which is the (meth)acrylic esters of polyesterols.

Useful polyesterols include, for example, those which can be prepared by esterifying polycarboxylic acids, preferably dicarboxylic acids, with polyols, preferably diols. The starting materials for such hydroxyl-containing polyesters are known to those skilled in the art. The dicarboxylic acids used may be succinic acid, glutaric acid, adipic acid, sebacic acid, o-phthalic acid, and their isomers and hydrogenation products, and also esterifiable or transesterifiable derivatives of the acids mentioned, for example anhydrides or dialkyl esters. Useful polyols include the abovementioned alcohols, preferably ethylene glycol, 1,2- and 1,3-propylene glycol, 1,4-butanediol, 1,6-hexanediol, neopentyl glycol, cyclohexanedimethanol and polyglycols of the ethylene glycol and propylene glycol type.

Also useful as reactive diluents of group (C.2.1) are 1,4-divinylbenzene, triallyl cyanurate, acrylic esters of tricyclodecenyl alcohol of the following formula

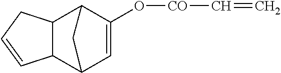

also known by the name dihydrodicyclopentadienyl acrylate, and the allyl esters of acrylic acid, of methacrylic acid and of cyanoacrylic acid.

Among the reactive diluents of group (C.2.1) mentioned by way of example, those used are especially, with regard to the preferred inventive mixtures addressed above, those which comprise photopolymerizable groups.

The group (C.2.2) includes, for example, di- or polyhydric alcohols, for example ethylene glycol, propylene glycol, and their more highly condensed representatives, for example diethylene glycol, triethylene glycol, dipropylene glycol, tripropylene glycol, etc., butanediol, pentanediol, hexanediol, neopentyl glycol, cyclohexanedimethanol, glycerol, trimethylolpropane, butanetriol, trimethylolethane, pentaerythritol, ditrimethylolpropane, dipentaerythritol, sorbitol, mannitol and the corresponding alkoxylated, especially ethoxylated and propoxylated, alcohols.

The group (C.2.2) also includes, for example, alkoxylated phenolic compounds, for instance ethoxylated or propoxylated bisphenols.

These reactive diluents may also, for example, be epoxide (meth)acrylates or urethane (meth)acrylates.

Epoxide (meth)acrylates are, for example, those as obtainable by reaction, known to those skilled in the art, of epoxidized olefins or poly- or diglycidyl ethers, such as bisphenol A diglycidyl ether, with (meth)acrylic acid.

Urethane (meth)acrylates are, in particular, reaction products, likewise known to those skilled in the art, of hydroxyalkyl (meth)acrylates with poly- or diisocyanates.

Such epoxide (meth)acrylates or urethane (meth)acrylates should be regarded as “mixed forms” of the compounds listed under groups (C.2.1) and (C.2.2).

When reactive diluents are used, their amount and properties have to be adjusted to the particular conditions in such a way that, on the one hand, a satisfactory desired effect, for example the desired color of the inventive mixtures, is achieved, but, on the other hand, the phase behavior of the liquid-crystalline mixture is not too greatly impaired. For the preparation of low-crosslinking (high-crosslinking) liquid-crystalline mixtures, it is possible, for example, to use corresponding reactive diluents which have a relatively low (high) number of reactive units per molecule.

The reactive diluents are typically used in a proportion of from 0.5 to 20.0% by weight based on the total weight of the liquid-crystalline mixture.

Components (a.1), (a.2) or (a.3), or mixtures which comprise these components, may also comprise small amounts of polymerizable diluents. Preferred polymerizable diluents which can be added to (a.1), (a.2) or (a.3) are acrylates, especially higher-functionality acrylates such as bis-, tris- or tetraacrylates, more preferably high-boiling oligoacrylates. The preferred amount added is about 5% by weight based on the total weight of the composition.

Group (C.3) of the solvents includes, for example, C₁-C₄-alcohols, for example methanol, ethanol, n-propanol, isopropanol, butanol, isobutanol, sec-butanol, tert-butanol, and the C₅-C₁₂-alcohols n-pentanol, n-hexanol, n-heptanol, n-octanol, n-nonanol, n-decanol, n-undecanol and n-dodecanol and isomers thereof, glycols, for example 1,2-ethylene glycol, 1,2- or 1,3-propylene glycol, 1,2-, 2,3- or 1,4-butylene glycol, di- or triethylene glycol or di- or tripropylene glycol, ethers, for example open-chain ethers such as methyl tert-butyl ether, 1,2-ethylene glycol monomethyl or dimethyl ether, 1,2-ethylene glycol monoethyl or diethyl ether, 3-methoxypropanol or 3-isopropoxypropanol, or cyclic ethers such as tetrahydrofuran or dioxane, open-chain ketones, for example acetone, methyl ethyl ketone, methyl isobutyl ketone or diacetone alcohol (4-hydroxy-4-methyl-2-pentanone), cyclic ketones such as cyclopentanone, or cyclohexanone, C₁-C₅-alkyl esters, for example methyl acetate, ethyl acetate, propyl acetate, butyl acetate or amyl acetate, C₁-C₄-alkoxy-C₁-C₄-alkyl esters such as 1-methoxyprop-2-yl acetate, carboxamides such as dimethylformamide and dimethylacetamide, N-heterocycles such as N-methylpyrrolidone, aliphatic or aromatic hydrocarbons, for example pentane, hexane, heptane, octane, isooctane, petroleum ether, toluene, xylene, ethylbenzene, tetralin, decalin, dimethylnaphthalene, white spirit, Shellsol® or Solvesso®, mineral oils, for example gasoline, kerosene, diesel oil or heating oil, but also natural oils, for example olive oil, soybean oil, rapeseed oil, linseed oil or sunflower oil. As a matter of course, mixtures of these solvents are also useful for use in the inventive mixtures.

When there is at least partial miscibility, these solvents may also be mixed with water. Useful solvents in this context are, for instance, C₁-C₄-alcohols, e.g. methanol, ethanol, n-propanol, isopropanol, butanol, isobutanol or sec-butanol, glycols, e.g. 1,2-ethylene glycol, 1,2- or 1,3-propylene glycol, 1,2-, 2,3- or 1,4-butylene glycol, di- or triethylene glycol or di- or tripropylene glycol, ethers, e.g. tetrahydrofuran or dioxane, ketones, e.g. acetone, methyl ethyl ketone or diacetone alcohol (4-hydroxy-4-methyl-2-pentanone), or C₁-C₄-alkyl esters, for example methyl acetate, ethyl acetate, propyl acetate or butyl acetate. Such aqueous mixtures often have limited miscibility with relatively nonpolar solvents, for example the aliphatic or aromatic hydrocarbons already mentioned, mineral oils but also natural oils, which then also allows ternary (or quasi-ternary) solvents composed of water, at least partly water-miscible and water-immiscible solvents to be prepared and used.

Suitable solvents for the compounds of groups (a.1) or (a.2) are especially linear or branched esters, particularly acetic esters, C₁-C₄-alkoxy-C₁-C₄-alkyl esters such as 1-methoxyprop-2-yl acetate, cyclic esters, carboxamides such as dimethylformamide and dimethylacetamide, open-chain and cyclic ethers, alcohols, lactones, open-chain and cyclic ketones, and aliphatic and aromatic hydrocarbons such as toluene, xylene and cyclohexane. Preferred solvents for the compounds of groups (a.1) or (a.2) are C₁-C₄-alkoxy-C₁-C₄-alkyl esters such as 1-methoxyprop-2-yl acetate, carboxamides such as dimethylformamide and dimethylacetamide, open-chain ethers such as 1,2-ethylene glycol mono- or dimethyl ether, 1,2-ethylene glycol mono- or diethyl ether, 3-methoxypropanol or 3-isopropoxypropanol, open-chain and cyclic ketones, such as acetone, methyl ethyl ketone, methyl isobutyl ketone, diacetone alcohol (4-hydroxy-4-methyl-2-pentanone) or cyclopentanone, or cyclohexanone, alcohols such as methanol, ethanol, n-propanol, isopropanol, butanol, isobutanol, sec-butanol, tert-butanol, n-pentanol, n-hexanol, n-heptanol, n-octanol, n-nonanol, n-decanol, n-undecanol and n-dodecanol, lactones such as N-methylpyrrolidone, and aromatics such as toluene. Greater preference is given to said carboxamides, open-chain ethers, open-chain and cyclic ketones and lactones. In particular, said open-chain and cyclic ketones or mixtures thereof are used.

Suitable solvents for the polymers of group (a.3) are in particular ethers and cyclic ethers such as tetrahydrofuran or dioxane, chlorinated hydrocarbons such as dichloromethane, trichloromethane, carbon tetrachloride, dichloroethane, 1,1,2,2-tetrachloroethane, 1-chloronaphthalene, chlorobenzene or 1,2-dichlorobenzene. These solvents are particularly suitable for polyesters and polycarbonates. Suitable solvents for cellulose derivatives are, for example, ethers, such as dioxane, or ketones such as acetone.

The reactive diluents are used typically in a proportion of from about 0.5 to 10.0% by weight, preferably from about 1.0 to 5.0% by weight, based on the total weight of the composition.

When the composition is a solution or dispersion, the proportion of solvent is preferably from 5 to 95% by weight, more preferably from 30 to 80% by weight and in particular from 40 to 70% by weight, based on the total weight of the composition.

The effect of the defoamers and deaerating agents (C.4), lubricants and leveling agents (C.5), thermally curing or radiation-curing auxiliaries (C.6), substrate wetting auxiliaries (C.7), wetting and dispersing auxiliaries (C.8), hydrophobizing agents (C.9), in-can stabilizers (C.10) and auxiliaries for improving scratch resistance (C.11) listed under component C usually cannot be strictly distinguished from one another. For instance, lubricants and leveling agents often additionally act as defoamers and/or deaerating agents and/or as auxiliaries for improving scratch resistance. Radiation-curing auxiliaries can in turn act as lubricants and leveling agents and/or deaerating agents and/or also as substrate wetting auxiliaries. In accordance with the above statements, a certain additive may therefore be attributed to more than one of the groups (C.4) to (C.11) described below.

The defoamers of group (C.4) include silicon-free and silicon-containing polymers. The silicon-containing polymers are, for example, unmodified or modified polydialkylsiloxanes or branched copolymers, comb copolymers or block copolymers composed of polydialkylsiloxane and polyether units, the latter being obtainable from ethylene oxide or propylene oxide.

The deaerating agents of group (C.4) include, for example, organic polymers, for instance polyethers and polyacrylates, dialkylpolysiloxanes, especially dimethylpolysiloxanes, organically modified polysiloxanes, for instance arylalkyl-modified polysiloxanes, or else fluorosilicones. The action of defoamers is based essentially on preventing foam formation or destroying foam which has already formed. Deaerating agents act essentially in such a way that they promote the coalescence of finely distributed gas or air bubbles to larger bubbles in the medium to be deaerated, for example the inventive mixtures, and hence accelerate the escape of the gas (or of the air). Since defoamers can often also be used as deaerating agents and vice versa, these additives have been combined together under group (C.4). Such auxiliaries are, for example, obtainable commercially from Tego as TEGO® Foamex 800, TEGO® Foamex 805, TEGO® Foamex 810, TEGO® Foamex 815, TEGO® Foamex 825, TEGO® Foamex 835, TEGO® Foamex 840, TEGO® Foamex 842, TEGO® Foamex 1435, TEGO® Foamex 1488, TEGO® Foamex 1495, TEGO® Foamex 3062, TEGO® Foamex 7447, TEGO® Foamex 8020, Tego® Foamex N, TEGO® Foamex K 3, TEGO® Antifoam 2-18, TEGO® Antifoam 2-57, TEGO® Antifoam 2-80, TEGO® Antifoam 2-82, TEGO® Antifoam 2-89, TEGO® Antifoam 2-92, TEGO® Antifoam 14, TEGO® Antifoam 28, TEGO® Antifoam 81, TEGO® Antifoam D 90, TEGO® Antifoam 93, TEGO® Antifoam 200, TEGO® Antifoam 201, TEGO® Antifoam 202, TEGO® Antifoam 793, TEGO® Antifoam 1488, TEGO® Antifoam 3062, TEGOPREN® 5803, TEGOPREN® 5852, TEGOPREN® 5863, TEGOPREN® 7008, TEGO® Antifoam 1-60, TEGO® Antifoam 1-62, TEGO® Antifoam 1-85, TEGO® Antifoam 2-67, TEGO® Antifoam WM 20, TEGO® Antifoam 50, TEGO® Antifoam 105, TEGO® Antifoam 730, TEGO® Antifoam MR 1015, TEGO® Antifoam MR 1016, TEGO® Antifoam 1435, TEGO® Antifoam N, TEGO® Antifoam KS 6, TEGO® Antifoam KS 10, TEGO® Antifoam KS 53, TEGO® Antifoam KS 95, TEGO® Antifoam KS 100, TEGO® Antifoam KE 600, TEGO® Antifoam KS 911, TEGO® Antifoam MR 1000, TEGO® Antifoam KS 1100, Tego® Airex 900, Tego® Airex 910, Tego® Airex 931, Tego® Airex 935, Tego® Airex 960, Tego® Airex 970, Tego® Airex 980 and Tego® Airex 985, and from BYK as BYK®-011, BYK®-019, BYK®-020, BYK®-021, BYK®-022, BYK®-023, BYK®-024, BYK®-025, BYK®-027, BYK®-031, BYK®-032, BYK®-033, BYK®-034, BYK®-035, BYK®-036, BYK®-037, BYK®-045, BYK®-051, BYK®-052, BYK®-053, BYK®-055, BYK®-057, BYK®-065, BYK®-067, BYK®-070, BYK®-080, BYK®-088, BYK®-141 and BYK®-A 530.

The auxiliaries of group (C.4) are typically used in a proportion of from about 0.05 to 3.0% by weight, preferably from about 0.5 to 2.0% by weight, based on the total weight of the liquid-crystalline mixture.

The group (C.5) of the lubricants and leveling agents includes, for example, silicon-free but also silicon-containing polymers, for example polyacrylates or modified low molecular weight polydialkylsiloxanes. The modification consists in replacing some of the alkyl groups with a wide variety of organic radicals. These organic radicals are, for example, polyethers, polyesters or else long-chain alkyl radicals, the former finding most frequent use.

The polyether radicals of the correspondingly modified polysiloxanes are typically formed by means of ethylene oxide and/or propylene oxide units. The higher the proportion of these alkylene oxide units is in the modified polysiloxane, the more hydrophilic is generally the resulting product.

Such auxiliaries are obtainable commercially, for example, from Tego as TEGO® Glide 100, TEGO® Glide ZG 400, TEGO® Glide 406, TEGO® Glide 410, TEGO® Glide 411, TEGO® Glide 415, TEGO® Glide 420, TEGO® Glide 435, TEGO® Glide 440, TEGO® Glide 450, TEGO® Glide A 115, TEGO® Glide B 1484 (also usable as a defoamer and deaerating agent), TEGO® Flow ATF, TEGO® Flow ATF2, TEGO® Flow 300, TEGO® Flow 460, TEGO® Flow 425 and TEGO® Flow ZFS 460. The radiation-curable lubricants and leveling agents used, which additionally also serve to improve scratch resistance, can be the products TEGO® Rad 2100, TEGO® Rad 2200, TEGO® Rad 2300, TEGO® Rad 2500, TEGO® Rad 2600, TEGO® Rad 2700 and TEGO® Twin 4000, likewise obtainable from Tego. Such auxiliaries are obtainable from BYK, for example as BYK®-300, BYK®-306, BYK®-307, BYK®-310, BYK®-320, BYK®-322, BYK®-331, BYK®-333, BYK®-337, BYK®-341, Byk® 354, Byk® 361 N, BYK®-378 and BYK®-388.

The auxiliaries of group (C.5) are typically used in a proportion of from about 0.005 to 1.0% by weight, preferably from about 0.01 to 0.2% by weight, based on the total weight of the liquid-crystalline mixture.

Group (C.6) includes, as radiation-curing auxiliaries, in particular polysiloxanes with terminal double bonds which are, for example, part of an acrylate group. Such auxiliaries can be made to crosslink by actinic or, for example, electron beam radiation. These auxiliaries generally combine several properties in one. In the uncrosslinked state, they can act as defoamers, deaerating agents, lubricants and leveling agents and/or substrate wetting aids; in the crosslinked state, they increase in particular the scratch resistance, for example of coatings or films which can be produced with the inventive mixtures. The improvement in the shine performance, for example, coatings or films can essentially be regarded as the effect of the action of these auxiliaries as defoamers, devolatilizers and/or lubricants and leveling agents (in the uncrosslinked state). The radiation-curing auxiliaries which can be used are, for example, the products TEGO® Rad 2100, TEGO® Rad 2200, TEGO® Rad 2500, TEGO® Rad 2600 and

TEGO® Rad 2700 obtainable from Tego, and the product BYK®-371 obtainable from BYK. Thermally curing auxiliaries of group (C.6) comprise, for example, primary OH groups which can react with isocyanate groups, for example, of the binder.

The thermally curing auxiliaries used can, for example, be the products BYK®-370, BYK®-373 and BYK®-375 obtainable from BYK. The auxiliaries of group (C.6) are typically used in a proportion of from about 0.1 to 5.0% by weight, preferably from about 0.1 to 3.0% by weight, based on the total weight of the liquid-crystalline mixture.

The auxiliaries of group (C.7) of the substrate wetting aids serve in particular to increase the wettability of the substrate, which is to be imprinted or coated, for instance, by printing inks or coating compositions, for example compositions (a.1) to (a.5). The generally associated improvement in the lubricating and leveling performance of such printing inks or coating compositions has an effect on the appearance of the finished (for example crosslinked) print or of the finished (for example crosslinked) layer. A wide variety of such auxiliaries are commercially available, for example, from Tego as TEGO® Wet KL 245, TEGO® Wet 250, TEGO® Wet 260 and TEGO® Wet ZFS 453, and from BYK as BYK®-306, BYK®-307, BYK®-310, BYK®-333, BYK®-344, BYK®-345, BYK®-346 and Byk®-348.

Also very suitable are the products of the Zonyl® brand from Dupont, such as Zonyl® FSA and Zonyl® FSG. These are fluorinated surfactants/wetting agents.

The auxiliaries of group (C.7) are typically used in a proportion of from about 0.01 to 3.0% by weight, preferably from about 0.01 to 1.5% by weight and especially from 0.03 to 1.5% by weight, based on the total weight of the liquid-crystalline mixture.

The auxiliaries of group (C.8) of the wetting and dispersing aids serve in particular to prevent the leaching and floating and also the settling of pigments, and are therefore useful, if necessary, in pigmented compositions in particular.

These auxiliaries stabilize pigment dispersions essentially by electrostatic repulsion and/or steric hindrance of the additized pigment particles, the interaction of the auxiliary with the surrounding medium (for example binder) playing a major role in the latter case. Since the use of such wetting and dispersing aids is common practice, for example, in the technical field of printing inks and paints, the selection of such a suitable auxiliary in the given case generally presents no difficulties to the person skilled in the art.

Such wetting and dispersing aids are supplied commercially, for example, by Tego as TEGO® Dispers 610, TEGO® Dispers 610 S, TEGO® Dispers 630, TEGO® Dispers 700, TEGO® Dispers 705, TEGO® Dispers 710, TEGO® Dispers 720 W, TEGO® Dispers 725 W, TEGO® Dispers 730 W, TEGO® Dispers 735 W and TEGO® Dispers 740 W, and by BYK as Disperbyk®, Disperbyk®-107, Disperbyk®-108, Disperbyk®-110, Disperbyk®-111, Disperbyk®-115, Disperbyk®-130, Disperbyk®-160, Disperbyk®-161, Disperbyk®-162, Disperbyk®-163, Disperbyk®-164, Disperbyk®-165, Disperbyk®-166, Disperbyk®-167, Disperbyk®-170, Disperbyk®-174, Disperbyk®-180, Disperbyk®-181, Disperbyk®-182, Disperbyk®-183, Disperbyk®-184, Disperbyk®-185, Disperbyk®-190, Anti-Terra®—U, Anti-Terra®—U 80, Anti-Terra®-P, Anti-Terra®-203, Anti-Terra®-204, Anti-Terra® 5 206, BYK®-151, BYK®-154, BYK®-155, BYK®-P 104 S, BYK®-P 105, Lactimon®, Lactimon®-WS and Bykumen®. The abovementioned Zonyl® brands, such as Zonyl® FSA and Zonyl® FSG, from DuPont are also useful here.

The dosage of the auxiliaries of group (C.8) depends mainly upon the surface area of the pigments to be covered and upon the mean molar mass of the auxiliary.

For inorganic pigments and low molecular weight auxiliaries, a content of the latter of from about 0.5 to 2.0% by weight based on the total weight of pigment and auxiliary is typically assumed. In the case of high molecular weight auxiliaries, the content is increased to from about 1.0 to 30% by weight.

In the case of organic pigments and low molecular weight auxiliaries, the content of the latter is from about 1.0 to 5.0% by weight based on the total weight of pigment and auxiliary. In the case of high molecular weight auxiliaries, this content may be in the range from about 10.0 to 90% by weight. In every case, therefore, preliminary experiments are recommended, which can, though, be accomplished by the person skilled in the art in a simple manner.

The hydrophobizing agents of group (C.9) can be used with a view, for example, to providing prints or coatings obtained with inventive mixtures with water-repellent properties. This means that swelling resulting from water absorption and hence a change, for example, in the optical properties of such prints or coatings is no longer possible or at least greatly suppressed. In addition, when the mixtures are used, for example, as a printing ink in offset printing, their absorption of water can be prevented or at least greatly inhibited. Such hydrophobizing agents are commercially available, for example, from Tego as Tego® Phobe WF, Tego® Phobe 1000, Tego® Phobe 1000 S, Tego® Phobe 1010, Tego® Phobe 1030, Tego® Phobe 1040, Tego® Phobe 1050, Tego® Phobe 1200, Tego® Phobe 1300, Tego® Phobe 1310 and Tego® Phobe 1400.

The auxiliaries of group (C.9) are used typically in a proportion of from about 0.05 to 5.0% by weight, preferably from about 0.1 to 3.0% by weight, based on the total weight of the liquid-crystalline mixture.

In-can stabilizers of group (C.10) provide increased storage stability from manufacturing to curing. Examples of in-can stabilizers of group (C.10) are:

Phosphites and phosphonites (processing stabilizer), for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenypethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS No. 939402-02-5), Phosphorous acid, triphenyl ester, polymer with alpha-hydro-omega-hydroxypoly[oxy(methyl-1,2-ethanediyl)], C10-16 alkyl esters (CAS No. 1227937-46-3). The following phosphites are especially preferred:

Tris(2,4-di-tert-butylphenyl) phosphite, tris(nonylphenyl) phosphite,

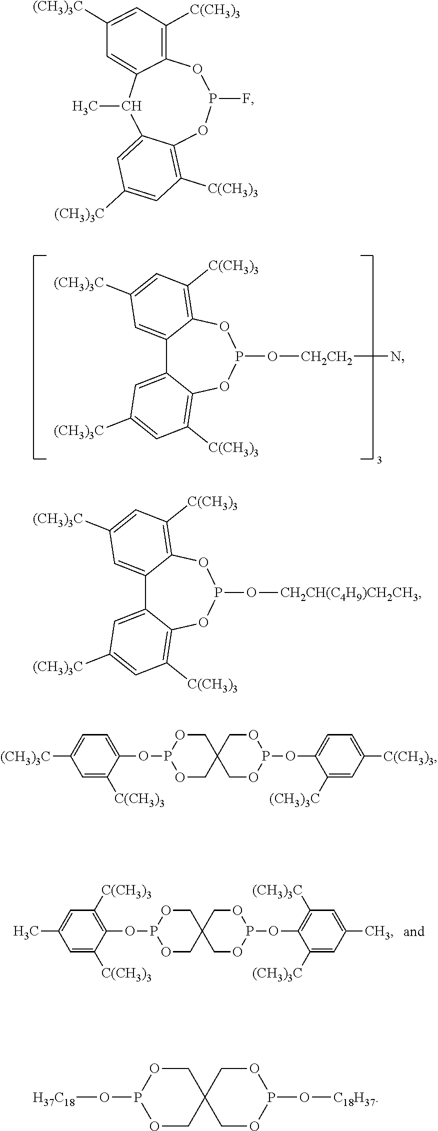

Quinone Methides of the Formula

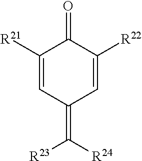

(providing long term shelf life stability), wherein

R²¹ and R²² independently of each other are C₁-C₁₈alkyl, C₅-C₁₂cycloalkyl, C₇-C₁₅-phenylalkyl, optionally substituted C₆-C₁₀aryl;

R²³ and R²⁴ independently of each other are H, optionally substituted C₆-C₁₀-aryl, 2-,3-,4-pyridyl, 2-,3-furyl or thienyl, COOH, COOR²⁵, CONH₂, CONHR²⁵, CONR²⁵R²⁶, —CN, —COR²⁵, —OCOR²⁵, —OPO(OR²⁵)₂, wherein R²⁵ and R²⁶ are independently of each other C₁-C₈alkyl, or phenyl. Quinone methides are preferred, wherein R²¹ and R²² are tert-butyl;

R²³ is H, and R²⁴ is optionally substituted phenyl, COOH, COOR²⁵, CONH₂, CONHR²⁵, CONR²⁵R²⁶, —CN, —COR²⁵, —OCOR²⁵, —OPO(OR²⁵)₂, wherein R²⁵ and R²⁶ are C₁-C₅alkyl, or phenyl. Examples of quinone methides are

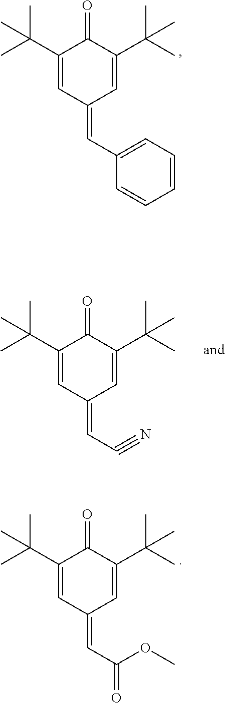

The quinone methides may be used in combination with highly sterically hindered nitroxyl radicals as described, for example, in US20110319535.

In-can stabilizers of group (C.10) are used typically in a proportion of from about 0.01 to 0.3% by weight, preferably from about 0.04 to 0.15% by weight, based on the total weight of the liquid-crystalline mixture.

The group (C.11) of the auxiliaries for improving scratch resistance includes, for example, the products TEGO® Rad 2100, TEGO® Rad 2200, TEGO® Rad 2500, TEGO® Rad 2600 and TEGO® Rad 2700 which are obtainable from Tego and have already been mentioned above.

For these auxiliaries, useful amounts are likewise those mentioned in group (C.6), i.e. these additives are typically used in a proportion of from about 0.1 to 5.0% by weight, preferably from about 0.1 to 3.0% by weight, based on the total weight of the liquid-crystalline mixture.

The group (D.1) of the dyes includes, for example, dyes from the class of the azo dyes, metal complex dyes, basic dyes such as di- and triarylmethane dyes and salts thereof, azomethine derivatives, polymethines, antraquinone dyes and the like. An overview of suitable dyes which can be used in the inventive mixture is given by the book by H. Zollinger, “Color Chemistry”, Wiley-VCH, Weinheim, 3^{rd} edition 2003.

It is in particular also possible to add to the inventive mixtures photochromic, thermochromic or luminescent dyes, and dyes which have a combination of these properties. In addition to the typical fluorescent dyes, fluorescent dyes should also be understood to mean optical brighteners.

Examples of the latter include the class of the bisstyrylbenzenes, especially of the cyanostyryl compounds, and correspond to the formula

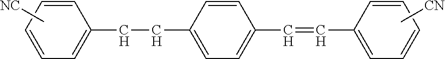

Further suitable optical brighteners from the class of the stilbenes are, for example, those of the formulae

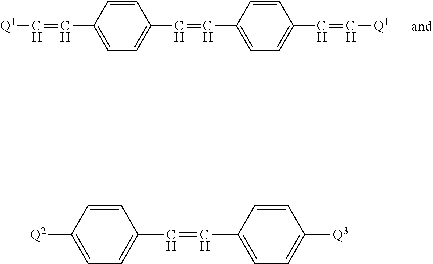

in which Q¹ is in each case C₁-C₄-alkoxycarbonyl or cyano, Q² is benzoxazol-2-yl, which may be mono- or disubstituted by C₁-C₄-alkyl, especially methyl, Q³ is C₁-C₄-alkoxycarbonyl or 3-(C₁-C₄-alkyl)-1,2,4-oxadiazol-3-yl.

Further suitable optical brighteners from the class of the benzoxazoles obey, for example, the formulae

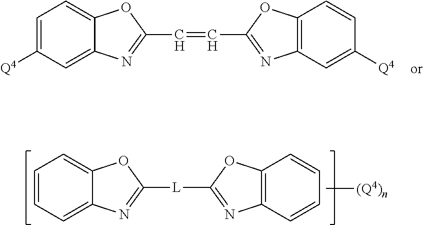

in which Q⁴ is in each case C₁-C₄-alkyl, especially methyl, L is a radical of the formula

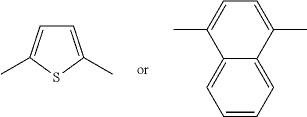

and n is an integer from 0 to 2.

Suitable optical brighteners from the class of the coumarins have, for example, the formula

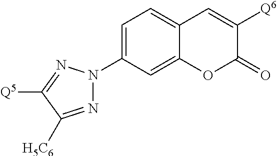

in which

Q⁵ is C₁-C₄-alkyl and

Q⁶ is phenyl or 3-halopyrazol-1-yl, especially 3-chloropyrazol-1-yl.

Further suitable optical brighteners from the class of the pyrenes correspond, for example, to the formula

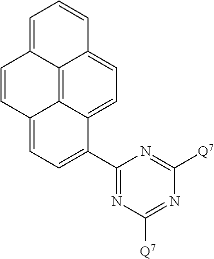

in which

Q⁷ is in each case C₁-C₄-alkoxy, especially methoxy.

The abovementioned brighteners can be used either alone or in a mixture with one another.

The abovementioned optical brighteners are generally commercially available products known per se. They are described, for example, in Ullmann's Encyclopedia of Industrial Chemistry, 5th edition, volume A18, pages 156 to 161, or can be obtained by the methods described there.

In particular, if desired, one or more optical brighteners from the class of the bisstyrylbenzenes is used, especially of the cyanostyrylbenzenes. The latter may be used as individual compounds, but also as a mixture of the isomeric compounds.

In this case, the isomers correspond to the formulae

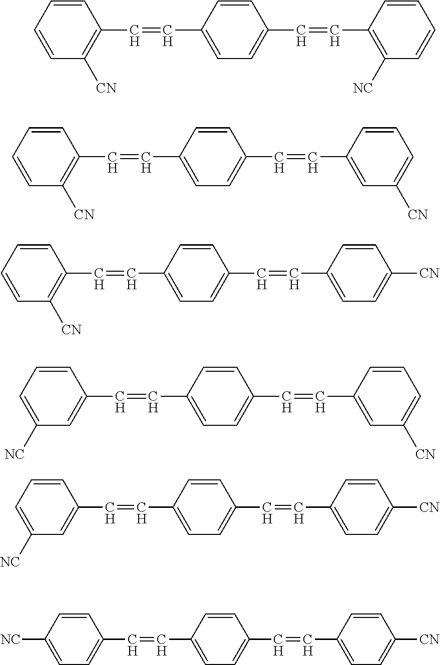

Optical brighteners are sold, for example, commercially as Ultraphor® SF 004, Ultraphor® SF MO, Ultraphor® SF MP and Ultraphor® SF PO from BASF SE.

The group (D.2) of the pigments includes both inorganic and organic pigments. An overview of inorganic colored pigments which can be used in the inventive mixtures is given by the book by H. Endriß “Aktuelle anorganische Bunt-Pigmente” [“Current inorganic colored pigments”] (publisher U. Zorll, Curt-R.-Vincentz-Verlag Hanover 1997), and the book by G. Buxbaum, “Industrial Inorganic Pigments”, Wiley-VCH, Weinheim, 3^{rd} edition 2005. In addition, useful further pigments which are not listed in the aforementioned book are also Pigment Black 6 and Pigment Black 7 (carbon black), Pigment Black 11 (iron oxide black, Fe₃O₄), Pigment White 4 (zinc oxide, ZnO), Pigment White 5 (lithopone, ZnS/BaSO₄), Pigment White 6 (titanium oxide, TiO₂) and Pigment White 7 (zinc sulfide, ZnS).

An overview of organic pigments which can be added to the inventive mixtures is provided by the book by W. Herbst and K. Hunger “Industrielle organische Pigmente” [“Industrial Organic Pigments”], Wiley-VCH, Weinheim, 3^{rd} edition 2004.

It is also possible to add to the inventive mixtures magnetic, electrically conductive, photochromic, thermochromic or luminescent pigments, and also pigments which have a combination of these properties.

In addition to some organic pigments, for example Lumogen® Yellow 0795 (BASF SE), useful pigments having luminescent properties are also inorganic, doped or undoped compounds essentially based on alkaline earth metal oxides, alkaline earth metal/transition metal oxides, alkaline earth metal/aluminum oxides, alkaline earth metal/silicon oxides or alkaline earth metal/phosphorus oxides, alkaline earth metal halides, Zn/silicon oxides, Zn/alkaline earth metal halides, rare earth metal oxides, rare earth metal/transition metal oxides, rare earth metal/aluminum oxides, rare earth metal/silicon oxides or rare earth metal/phosphorus oxides, rare earth metal oxide sulfides or oxide halides, zinc oxide, sulfide or selenide, cadmium oxide, sulfide or selenide or zinc/cadmium oxide, sulfide or selenide, the cadmium compounds being of lower importance owing to their toxicological and ecological relevance.

The dopants used in these compounds are usually aluminum, tin, antimony, rare earth metals, such as cerium, europium or terbium, transition metals, such as manganese, copper, silver or zinc, or combinations of these elements.

Luminescent pigments are specified below by way of example, the notation “compound:element(s)” being taken to mean to the relevant person skilled in the art that said compound has been doped with the corresponding element(s). In addition, for example, the notation “(P,V)”, denotes that the corresponding lattice positions in the solid structure of the pigment are randomly occupied by phosphorus and vanadium.

Examples of such compounds which are capable of luminescence are MgWO₄, CaWO₄, Sr₄Al₁₄O₂₅:Eu, BaMg2A110027:Eu, MgAl₁₁O₁₉:Ce,Tb, MgSiO₃:Mn, Ca₁₀(PO₄)₆(F,Cl):Sb,Mn, (SrMg)₂P₂O₇:Eu, SrMg₂P₂O₇:Sn, BaFCl:Eu, Zn₂SiO₄:Mn, (Zn,Mg)F₂:Mn, Y₂O₃:Eu, YVO₄:Eu, Y(P,V)O₄:Eu, Y₂SiO₅:Ce,Tb, Y₂O_{2S}:Eu, Y₂O_{2S}:Tb, La₂O₂S:Tb, Gd₂O₂S:Tb, LaOBr:Tb, ZnO:Zn, ZnS:Mn, ZnS:Ag, ZnS/CdS:Ag, ZnS:Cu,Al, ZnSe:Mn, ZnSe:Ag and ZnSe:Cu.

Since the inventive film is preferably intended to be essentially transparent, the components of group D are used in not more than such amounts that the film transmits at least 80% of the incident radiation with a wavelength of from 350 to 750 nm. Component D is used to impart a tint to the film, if desired. In order to ensure maximum transparency, the compounds of component D used are preferably those having a particle size of not more than 20 nm.

Examples of light, heat and/or oxidation stabilizers as component E include:

alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(a-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which have a linear or branched side chain, for example 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures of these compounds, alkylthiomethylphenols, such as 2,4-dioctylthiomethyl-6-tert-butylphenol, 2,4-dioctylthiomethyl-6-methylphenol, 2,4-dioctylthiomethyl-6-ethylphenol and 2,6-didodecylthiomethyl-4-nonylphenol, hydroquinones and alkylated hydroquinones, such as 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate and bis(3,5-di-tert-butyl-4-hydroxyphenyl)adipate, tocopherols, such as α-tocopherol, β-tocopherol, γ-tocopherol, δ-tocopherol and mixtures of these compounds, and tocopherol derivatives, such as tocopheryl acetate, succinate, nicotinate and polyoxyethylenesuccinate (“tocofersolate”),

hydroxylated diphenyl thioethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol) and 4,4′-bis(2,6-dimethyl-4-hydroxyphenyl) disulfide, alkylidenebisphenols, such as 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl] terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecyl-mercaptobutane and 1,1,5,5-tetrakis(5-tert-butyl-4-hydroxy-2-methylphenyl)pentane,

O-, N- and S-benzyl compounds, such as 3,5,3′,5′-tetra-tert-butyl-4,4′-dihydroxydibenzyl ether, octadecyl 4-hydroxy-3,5-dimethylbenzylmercaptoacetate, tridecyl 4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl) dithioterephthalate, bis(3,5-di-tert-butyl-4-hydroxybenzyl) sulfide and isooctyl-3,5-di-tert-butyl-4-hydroxybenzylmercaptoacetate,

aromatic hydroxybenzyl compounds, such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene and 2,4,6-tris(3,5-di-tert-butyl-4-hydroxybenzyl)phenol, triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris-(3,5-di-tert-butyl-4-hydroxyphenylpropionyl)hexahydro-1,3,5-triazine, 1,3,5-tris(3,5-dicyclohexyl-4-hydroxybenzyl) isocyanurate and 1,3,5-tris(2-hydroxyethyl) isocyanurate,

benzylphosphonates, such as dimethyl 2,5-di-tert-butyl-4-hydroxybenzylphosphonate, diethyl 3,5-di-tert-butyl-4-hydroxybenzylphosphonate, dioctadecyl 3,5-di-tert-butyl-4-hydroxybenzylphosphonate and dioctadecyl 5-tert-butyl-4-hydroxy-3-methylbenzylphosphonate, acylaminophenols, such as 4-hydroxylauroylanilide, 4-hydroxystearoylanilide and octyl N-(3,5-di-tert-butyl-4-hydroxyphenyl)carbamate,

propionic and acetic esters, for example of monohydric or polyhydric alcohols, such as methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane and 4-hydroxymethyl-1-phospha-2,6,7-trioxabicyclo[2.2.2]octane,

propionamides based on amine derivatives, such as N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine and N,N′-bis(3,5-di-tert-butyl-4-hydroxyphenylpropionyl)hydrazine,

ascorbic acid (Vitamin C) and ascorbic acid derivatives, such as ascorbyl palmitate, laurate and stearate, and ascorbyl sulfate and phosphate,

antioxidants based on amine compounds, such as N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octyl-substituted diphenylamine, such as p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis[4-methoxyphenyl)amine, 2,6-di-tert-butyl-4-dimethylaminomethylphenol, 2,4-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4(1′,3′-dimethylbutyl)phenyl]amine, tert-octyl-substituted N-phenyl-1-naphthylamine, a mixture of mono- and dialkylated tert-butyl/tert-octyldiphenylamine, a mixture of mono- and dialkylated nonyldiphenylamine, a mixture of mono- and dialkylated dodecyldiphenylamine, a mixture of mono- and dialkylated isopropyl/isohexyldiphenylamine, a mixture of mono- and dialkylated tert-butyldiphenylamine, 2,3-dihydro-3,3-dimethyl-4H-1,4-benzothiazine, phenothiazine, a mixture of mono- and dialkylated tert-butyl/tert-octylphenothiazine, a mixture of mono- and dialkylated tert-octylphenothiazine, N-allylphenothiazine, N,N,N′,N′-tetraphenyl-1,4-diaminobut-2-ene, N,N-bis(2,2,6,6-tetramethylpiperid in-4-yl)hexamethylenediamine, bis(2,2,6,6-tetramethylpiperidin-4-yl) sebacate, 2,2,6,6-tetramethylpiperidin-4-one and 2,2,6,6-tetramethylpiperidin-4-ol, phosphites and phosphonites, such as triphenylphosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, diisodecyloxy pentaerythritol diphosphite, bis(2,4-di-tert-butyl-6-methylphenyl) pentaerythritol diphosphite, bis(2,4,6-tris(tert-butylphenyl)) pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyl-dibenzo[d,g]-1,3,2-dioxaphosphocine, bis(2,4-di-tert-butyl-6-methylphenyl) methyl phosphite and bis(2,4-di-tert-butyl-6-methylphenyl) ethyl phosphite,

2-(2′-hydroxyphenyl)benzotriazoles, such as 2-(2′-hydroxy-5′-methylphenyl)benzotriazole, 243%5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 243′,5′-bis-(α,α-dimethylbenzyl)-2′-hydroxyphenyl)benzotriazole, a mixture of 2-(3′-tert-butyl-2′-hydroxy-5′-(2-octyloxycarbonylethyl)phenyl)-5-chlorobenzotriazole, 243′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 243′-tert-butyl-2′-hydroxy-5′-(2-octyloxycarbonylethyl)phenyl)benzotriazole, 243′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the product of complete esterification of 2-[3′-tert-butyl-5′-(2-methoxycarbonylethyl)-2′-hydroxyphenyl]-2H-benzotriazole with polyethylene glycol 300; [R—CH₂CH₂—COO(CH₂)₃]₂, where R=3′-tert-butyl-4′-hydroxy-5′-2H-benzotriazol-2-ylphenyl], sulfur-containing peroxide scavengers and sulfur-containing antioxidants, such as esters of 3,3′-thiodipropionic acid, for example the lauryl, stearyl, myristyl and tridecyl esters, mercaptobenzimidazole and the zinc salt of 2-mercaptobenzimidazole, dibutylzinc dithiocarbamate, dioctadecyl disulfide and pentaerythritol tetrakis(p-dodecylmercapto)propionate, 2-hydroxybenzophenones, such as the 4-hydroxy, 4-methoxy, 4-octyloxy, 4-decycloxy, 4-dodecyloxy, 4-benzyloxy, 4,2′,4′-trihydroxy and 2′-hydroxy-4,4′-dimethoxy derivatives, esters of unsubstituted and substituted benzoic acids, such as 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl-3,5-di-tert-butyl-4-hydroxybenzoate, octadecyl-3,5-di-tert-butyl-4-hydroxybenzoate and 2-methyl-4,6-di-tert-butylphenyl-3,5-di-tert-butyl-4-hydroxybenzoate,

acrylates, such as ethyl α-cyano-β,β-diphenylacrylate, isooctyl α-cyano-β,β-diphenylacrylate, methyl α-methoxycarbonylcinnamate, methyl α-cyano-β-methyl-p-methoxycinnamate, butyl-α-cyano-β-methyl-p-methoxycinnamate and methyl-α-methoxycarbonyl-p-methoxycinnamate, sterically hindered amines, such as bis(2,2,6,6-tetramethylpiperidin-4-yl) sebacate, bis(2,2,6,6-tetramethylpiperidin-4-yl) succinate, bis(1,2,2,6,6-pentamethylpiperidin-4-yl) sebacate, bis(1-octyloxy-2,2,6,6-tetramethylpiperidin-4-yl) sebacate, bis(1,2,2,6,6-pentamethylpiperidin-4-yl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, the condensation product of N,N′-bis(2,2,6,5-tetramethylpiperidin-4-yl)hexamethylenediamine and 4-tert-octylamino-2,6-dichloro-1,3,5-triazine, tris(2,2,6,6-tetramethylpiperidin-4-yl) nitrilotriacetate, tetrakis(2,2,6,6-tetramethylpiperidin-4-yl) 1,2,3,4-butanetetracarboxylate, 1,1′-(1,2-ethylene)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidin-4-yl) 2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidin-4-yl) sebacate, bis(1-octyloxy-2,2,6,5-tetramethylpiperidin-4-yl) succinate, the condensation product of N,N′-bis(2,2,6,6-tetramethylpiperidin-4-yl)hexamethylenediamine and 4-morpholino-2,6-dichloro-1,3,5-triazine, the condensation product of 2-chloro-4,6-bis(4-n-butylamino-2,2,6,6-tetramethylpiperidin-4-yl)-1,3,5-triazine and 1,2-bis(3-aminopropylamino)ethane, the condensation product of 2-chloro-4,6-di(4-n-butylamino-1,2,2,6,6-pentamethylpiperidin-4-yl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethylpiperidin-4-yl)pyrrolidine-2,5-dione, 3-dodecyl-1-(1,2,2,6,6-pentamethylpiperidin-4-yl)pyrrolidine-2,5-dione, a mixture of 4-hexadecyloxy- and 4-stearyloxy-2,2,6,6-tetramethylpiperidine, the condensation product of N,N′-bis(2,2,6,6-tetramethylpiperidin-4-yl)hexamethylenediamine and 4-cyclohexylamino-2,6-dichloro-1,3,5-triazine, the condensation product of 1,2-bis(3-aminopropylamino)ethane and 2,4,6-trichloro-1,3,5-triazine, 4-butylamino-2,2,6,6-tetramethylpiperidine, N-(2,2,6,6-tetramethylpiperidin-4-yl)-n-dodecylsuccinimide, N-(1,2,2,6,6-pentamethylpiperidin-4-yl)-n-dodecylsuccinimide, 2-undecyl-7,7,9,9-tetramethyl-1-oxa-3,8-diaza-4-oxo-spiro[4.5]decane, the condensation product of 7,7,9,9-tetramethyl-2-cycloundecyl-1-oxa-3,8-diaza-4-oxospiro-[4.5]decane and epichlorohydrin, the condensation products of 4-amino-2,2,6,6-tetramethylpiperidine with tetramethylolacetylenediureas and poly(methoxypropyl-3-oxy)-[4(2,2,6,6-tetramethyl)piperidinyl]siloxane,

oxamides, such as 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, and mixtures of ortho-, para-methoxy-disubstituted oxanilides and mixtures of ortho- and para-ethoxy-disubstituted oxanilides, and 2-(2-hydroxyphenyl)-1,3,5-triazines, such as 2,4,6-tris-(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methyl-5 phenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropoxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

The components F of the IR absorber used are compounds which exhibit one or more absorption bands in the infrared spectral region, i.e. from >750 nm, e.g. from 751 nm, to 1 mm. Preference is given to compounds which exhibit one absorption band in the near infrared (NIR) spectral region, i.e. from >750 (e.g. 751) to 2000 nm, and optionally additionally also in the visible spectral region, especially from 550 to 750 nm. When the compounds absorb both in the IR and in the visible spectral region, they preferably exhibit the greatest absorption maximum in the IR region and a smaller maximum (frequently in the form of a so-called absorption shoulder) in the visible region. In a particular embodiment, the compounds of component F additionally also exhibit fluorescence. Fluorescence is the transition of a system excited by absorption of electromagnetic radiation (usually visible light, UV radiation, X-rays or electron beams) to a state of lower energy by spontaneous emission of radiation of the same wavelength (resonance fluorescence) or longer wavelength. Preferred compounds of component F exhibit, when they fluoresce, a fluorescence in the IR spectral region, preferably in the NIR.

Such compounds are, for example, selected from naphthalenes, anthracenes, phenanthrenes, tetracenes, perylenes, terrylenes, quaterrylenes, pentarylenes, hexarylenes, anthraquinones, indanthrones, acridines, carbazoles, dibenzofuranes, dinaphthofuranes, benzimidazoles, benzthiazoles, phenazines, dhoxazines, quinacridones, metal phthalocyanines, metal naphthalocyanines, metal porphyrines, coumarines, dibenzofuranones, dinaphthofuranones, benzimidazolones, indigo compounds, thioindigo compounds, quinophthalones, naphthoquinophthalones and diketopyrrolopyrroles. Particularly preferred compounds of component F which absorb IR radiation and optionally fluoresce are selected from naphthalenes, anthracenes, phenanthrenes, tetracenes, perylenes, terrylenes, quaterrylenes, pentarylenes and hexarylenes, more preferably from perylenes, terrylenes and quaterrylenes and especially from terrylenes and quaterrylenes. The compound is especially a quaterrylene. Suitable compounds are described in WO 2008/012292, which is hereby fully incorporated by reference.

In a particularly preferred embodiment the liquid crystal composition comprises as component A.1:

one or more compounds of the general formula Ib

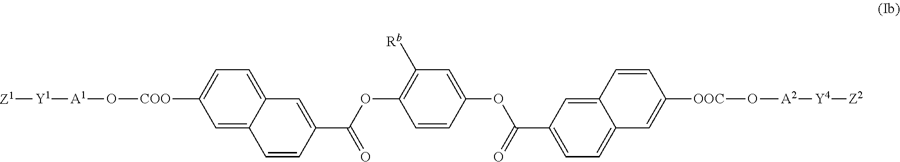

in which the variables are defined as follows:

Z¹, Z² are each independently

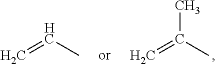

A¹, A² are each independently spacers having 4 to 8 carbon atoms,

Y¹, Y⁴ are each independently a single chemical bond, oxygen, —CO—, —O—CO— or —CO—O—,

R^{b} is hydrogen, C₁-C₆-alkyl or CO—O—C₁-C₆-alkyl,

as component A.1:

one or more compounds of the general formula Ia

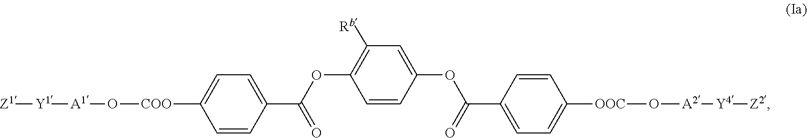

in which the variables are defined as follows:

Z^{1′}, Z^{2′} are each independently

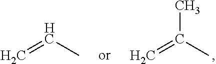

A^{1′}, A^{2′} are each independently spacers having 4 to 8 carbon atoms,

Y^{1′}, Y^{4′} are each independently a single chemical bond, oxygen, —CO—, —O—CO— or —CO—O—,

R^{b′} is hydrogen, C₁-C₆-alkyl or CO—O—C₁-C₆-alkyl, as component B.1:

one or more substances selected from the group consisting of:

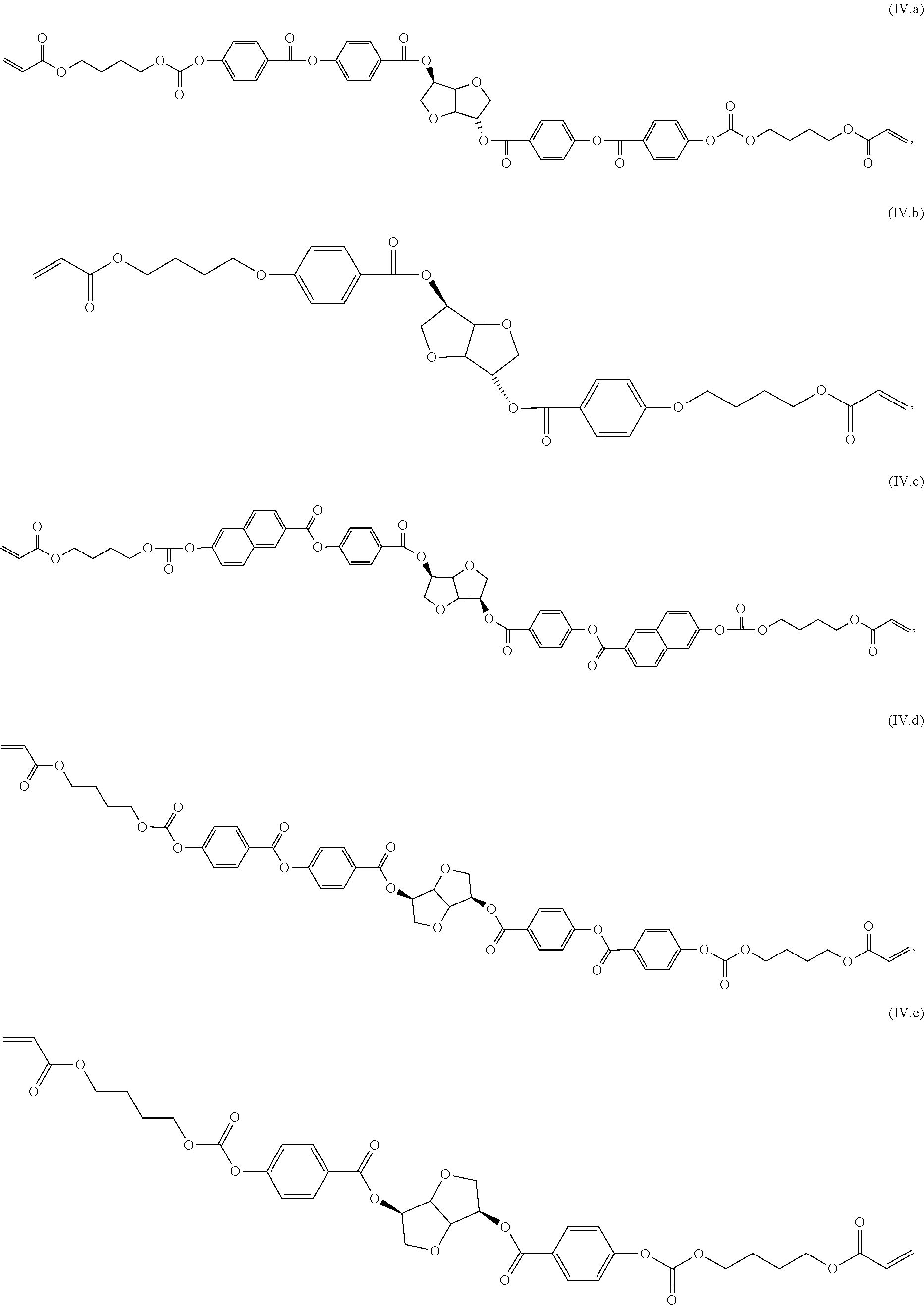

as component C:

one or more substances selected from the group consisting of:

C.1 photoinitiators;

C.3 solvents;

C.5 leveling agents, and

C.10 in-can stabilizers.

The liquid crystal composition comprises
10-50% by weight, preferably 20-40% by weight of component(s) A.1 and B.1 based on total weight of component(s) A.1, B.1 and C.3;
50-90% by weight, preferably 60-80% of solvent(s) C.3;
0.5-10% by weight, preferably 1-5% by weight of photoinitiator(s) C.1 based on total weight of component(s) A.1 and B.1;
0.01-1% by weight, preferably 0.01-0.2% by weight of levelling agent(s) C.5 based on total weight of component(s) A.1 and B.1;
0.01-0.3% by weight, preferably 0.4-0.15% by weight of stabilizer(s) based on total weight of component(s) A.1 and B.1.

In addition, the present invention relates to (security) elements, which comprise

a flexible substrate,

a primer layer and

a liquid crystal film, and are obtainable by the process according to the invention.

The security element may comprise one, or more further layers, which are selected from black layers, white layers, metallic layers, plasmonic layers, embossed layers with diffractive gratings and/or micromirrors and/or lenses, magnetic layers, fluorescent layers, interference layers, plasmonic layers, colored layers, IR-absorbing layers, IR-transparent layers and conductive layers. The layers might be fully, or partially printed on the security element.

The security element, might be part of a security document. Accordingly, the present invention is directed to a security document, comprising the security element of the present invention as a laminate onto the document or embedded as a (windowed) thread into the document or as a window on the document. The production of window threads is, for example, described in EP319157, WO14108329 and WO03054297. The security document can be, for example, a banknote, tax stamp, ID-card, voucher, entrance ticket, or label.

Various aspects and features of the present invention will be further discussed in terms of the examples. The following examples are intended to illustrate various aspects and features of the present invention.

### EXAMPLES

Primer Formulation:

| Compound | Weight (g) |
|---|---|
| Photoinitiator¹⁾ | 6.07 |
| Sartomer ® 344 (polyethylene glycol (400) | 3.45 |
| diacrylate) | |
| Isopropanol | 495.24 |
| 1,2-dimethoxypropanol | 495.24 |

¹⁾Compound of formula (V), wherein n is 1, and R¹¹ is a group of formula 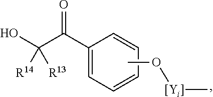
in which R¹³ and R¹⁴ each independently of one another are an alkyl group containing 1 to 4 carbon atoms, Yᵢ for is a group of —CH₂—CH₂—O—, —CH₂—CH(CH₃)—O—, and —CH(CH₃)—CH₂—O—, preferably —CH₂—CH₂—O—.

LC 1: compound I.a

LC 2: compound I.b

Dopant: compound IV.a

Liquid crystal ink for examples 1-4

| | Mixture A | | Mixture B | | Mixture C | | Mix D | |
|---|---|---|---|---|---|---|---|---|
| LC 1 | 49.4420 | g | 0.0000 | | 24.7210 | g | 83.631 | g |
| LC 2 | 0.0000 | | 48.8365 | g | 24.4183 | g | 250.893 | g |
| Dopant | 2.3081 | g | 2.9135 | g | 2.6108 | g | 18.689 | g |
| Irgacure 907 | 2.5875 | g | 0.0000 | | 1.2938 | g | 0.000 | |
| Irgacure TPO | 0.0000 | | 2.5875 | g | 1.2938 | g | 17.507 | g |
| BYK 361N | 0.0259 | g | 0.0259 | g | 0.0259 | g | 0.175 | g |
| Cyclopentanone | 93.45 | g | 93.45 | g | 93.45 | g | 632.28 | g |

### Comparative Examples 1-3

The liquid crystal based ink is applied with a 12 μm spiral applicator on Lumirror® 40.01 film, dried in a convection oven and UV cured. The liquid crystal film shows an excellent color flop from red to green. Adhesion test is done with a 90° peel test.

| Comparative | Liquid | Drying | UV |
|---|---|---|---|
| Example | crystal ink | temperature | curing |
| 1 | Mix A | 90° C. | Mercury lamp |
| 2 | Mix B | 105° C. | Mercury lamp |
| 3 | Mix C | 130° C. | Mercury lamp |

### Examples 1α-d to 3α-d

The primer formulation is applied with a spiral applicator on PET film Lumirror® 40.01, dried 2 minutes at 80° C. in a convection oven, followed by UV curing.

The spiral applicator used for the primer formulation is indicated in the table.

The liquid crystal based ink is applied subsequently using a 12 μm spiral applicator, followed by drying in a convection oven and UV curing. The liquid crystal film shows a good color flop from red to green. Adhesion test is done with a 90° peel test.

| | Spiral applicator | | Drying | |
|---|---|---|---|---|
| | for primer | Liquid | temperature | |
| Example | formulation | crystal ink | of LC ink | UV curing |
| 1a | 4 μm | Mix A | 90° C. | Mercury lamp |
| 1b | 6 μm | Mix A | 90° C. | Mercury lamp |
| 1c | 12 μm | Mix A | 90° C. | Mercury lamp |
| 1d | 24 μm | Mix A | 90° C. | Mercury lamp |
| 2a | 4 μm | Mix B | 105° C. | Mercury lamp |
| 2b | 6 μm | Mix B | 105° C. | Mercury lamp |
| 2c | 12 μm | Mix B | 105° C. | Mercury lamp |
| 2d | 24 μm | Mix B | 105° C. | Mercury lamp |
| 3a | 4 μm | Mix C | 130° C. | Mercury lamp |
| 3b | 6 μm | Mix C | 130° C. | Mercury lamp |
| 3c | 12 μm | Mix C | 130° C. | Mercury lamp |
| 3d | 24 μm | Mix C | 130° C. | Mercury lamp |

The alignment of the liquid crystals is slightly affected when printed on the top of the primer, resulting in an increased number of microdomains as can be seen under a microscope. The adhesion performance is good.

The adhesion performance of the liquid crystal film on the PET film with and without primer is also tested with a 90° peel test.

Peel tester: Zwicki BZ1.0/TH1S

Test conditions:

| | |
|---|---|
| Peel angle | 90° |
| Tape width | 15 mm |
| Temperature/Humidity: | 23° C./50% humidity |
| Force sensor | 50N |
| Test speed | 50 mm/min |
| Peelarm | Scotch over a length of 15 cm |

Results:

| Sample of | Primer | Peelforce [N/m] |
|---|---|---|
| Comparative | No | 6.4 |
| Example 1 | | |
| Example 1a | yes | 24 |
| Example 1b | yes | 23 |
| Example 1c | yes | 23 |
| Example 1d | yes | 23 |
| Comparative | No | 4.2 |
| Example 2 | | |
| Example 2a | yes | 24 |
| Example 2b | yes | 22 |
| Example 2c | yes | 24 |
| Example 2d | yes | 20 |
| Comparative | No | 2.7 |
| Example 3 | | |
| Example 3a | yes | 19 |
| Example 3b | yes | 20 |
| Example 3c | yes | 23 |
| Example 3d | yes | 24 |

### Comparative Example 4

The liquid crystal based ink Mix D is gravure printed on Hostaphan® RNK 23 micron film using a 701/cm gravure cylinder, dried at 100° C. and UV-cured with a Ga doped Hg lamp. Adhesion is tested by tape test.

### Example 4

Hostaphan® RNK, a biaxially oriented polyethylene terephthalate (BOPET) film, is subjected to a corona treatment at an output of 350 W min/m² (SOFTAL, Type CLNE015-130-1KB3) The primer formulation is printed first by gravure using a 1001/cm ceramic cylinder on the BOPET film, drying temperature of the printing press: 70° C., UV curing: Mercury lamp, printing speed: 10 m/min. The liquid crystal based ink Mix D is printed subsequently using a 701/cm cylinder.

Adhesion is Assessed by Tape Test

| | Adhesion | Surface tension as | Optical |
|---|---|---|---|
| Sample of | promoter | delivered (mN/m) | Effect |
| Comparative | No | 41 | Excellent color flop from |
| Example 4 | | | green to blue, no adhesion |
| Example 4 | yes | 50 | Good color flop from |
| | | | green to blue, Good adhesion |

The alignment of the liquid crystals is slightly affected when printed on the top of the primer, resulting in an increased number of microdomains as can be seen under a microscope. The adhesion performance is good.

The adhesion performance of the liquid crystal film on the PET film with and without primer is also tested with a 90° peel test.

Peel tester: Zwicki BZ1.0/TH1S

Test Conditions:

| | |
|---|---|
| Peel angle | 90° |
| Tape width | 15 mm |
| Temperature/Humidity: | 23° C./50% humidity |
| Force sensor | 50N |
| Test speed | 50 mm/min |
| Peelarm | Scotch over a length of 15 cm |

Results:

| Sample of | Primer | Peelforce [N/m] |
|---|---|---|
| Comparative | No | 2.1 |
| Example 4 | | |
| Example 4 | yes | 51 |

When measuring the transmission spectrum of the liquid crystal film on the PET film with primer (Example 4) and without primer (Comparative Example 4) the difference of the transmission minimum of the liquid crystal film on the PET film with primer and without primer is less than 20 nm. The transmission minimum represents the wavelength at the halfwidth of the transmission band at 80% transmission. That means, the adherence of the liquid crystal film to the substrate is improved in Example 4 while simultaneously keeping the optical performance of the liquid crystal film in an acceptable range.

1. A process for producing an adherent liquid crystal films on a flexible substrate, the process comprising
(a) optionally, exposing the flexible substrate to a corona discharge or a plasma discharge treatment;
(b) applying on the substrate a primer composition comprising (b1) a polyurethane (A) comprising, in reacted form, (b1a) an organic polyisocyanate having a functionality of at least 2, (b1b) a compound comprising an isocyanate-reactive group and a radically polymerizable unsaturated group, (b1c) a photoinitiator comprising an isocyanate-reactive group, (b2) a polyfunctional polymerizable compound (B), and (b3) a solvent;
(c) evaporating the solvent with IR-radiation and/or thermal drying, to obtain an uncured primer layer;
(d) curing the uncured primer layer with UV/VIS radiation or an electron beam, to obtain a primered substrate;
(e) optionally, exposing the primered substrate to a corona discharge or a plasma discharge treatment;
(f) applying a liquid crystal composition onto a primer coating of the primered substrate; the primer coating,
(g) evaporating the solvent by applying IR-radiation and/or thermal drying, to obtain a liquid crystal film; and
(h) curing the liquid crystal film with UV/VIS radiation or electron beam.

2. The process of claim 1, wherein the flexible substrate is a biaxially oriented polyethylene terephthalate film or a biaxially oriented polypropylene film.

3. The process of claim 1, wherein the primer composition is applied by slot die-coating, knive-coating, reverse roll-coating, metering rod coating, gravure-printing, flexo-printing, screen-printing, or ink jet printing.

4. The process of claim 1, wherein the liquid crystal composition is applied by slot die-coating, knive-coating, reverse roll-coating, metering rod coating, gravure-printing, flexo-printing, screen-printing, or ink jet printing.

5. The process of claim 1, wherein the liquid crystal film has a peel_force >20 N/m.

6. The process of claim 1, wherein the liquid crystal composition comprises:
an achiral nematic polymerizable monomer; and
a chiral polymerizable monomer;
a substance comprising a photoinitiator; a reactive diluent comprising a photopolymerizable group; solvent, defoamer, deaerator, lubricant, leveling agent, thermally curing auxiliary, radiatively curing auxiliary, substrate wetting aid, wetting aid, dispersing aid, hydrophobizing agent, in-can stabilizer, and/or a scratch resistance auxiliary; and
a component comprising a dye and/or pigment.

7. The process of claim 6, wherein the achiral nematic polymerizable monomer comprises a compound of formula (Ib) or (Ia) 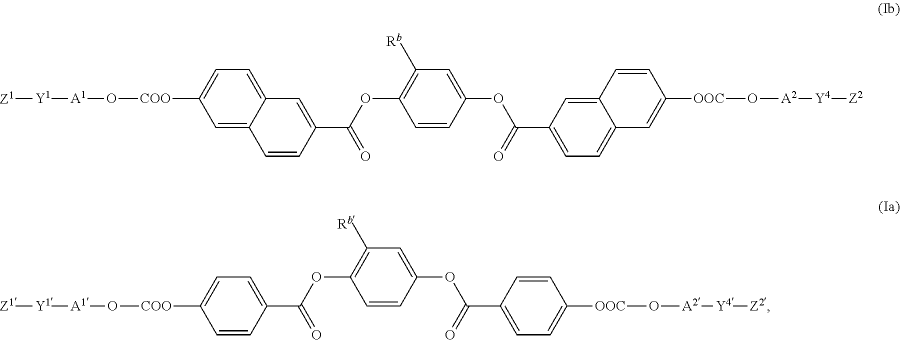
wherein
Z¹ and Z² are independently 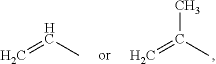
A¹ and A² are independently spacers comprising 4 to 8 carbon atoms,
Y¹ and Y⁴ are independently a single chemical bond, oxygen, —CO—, —O—CO—, or —CO—O—,
R^{b} is hydrogen, C₁-C₆-alkyl, or CO—O—C₁-C₆-alkyl;
wherein the chiral polymerizable monomer composes 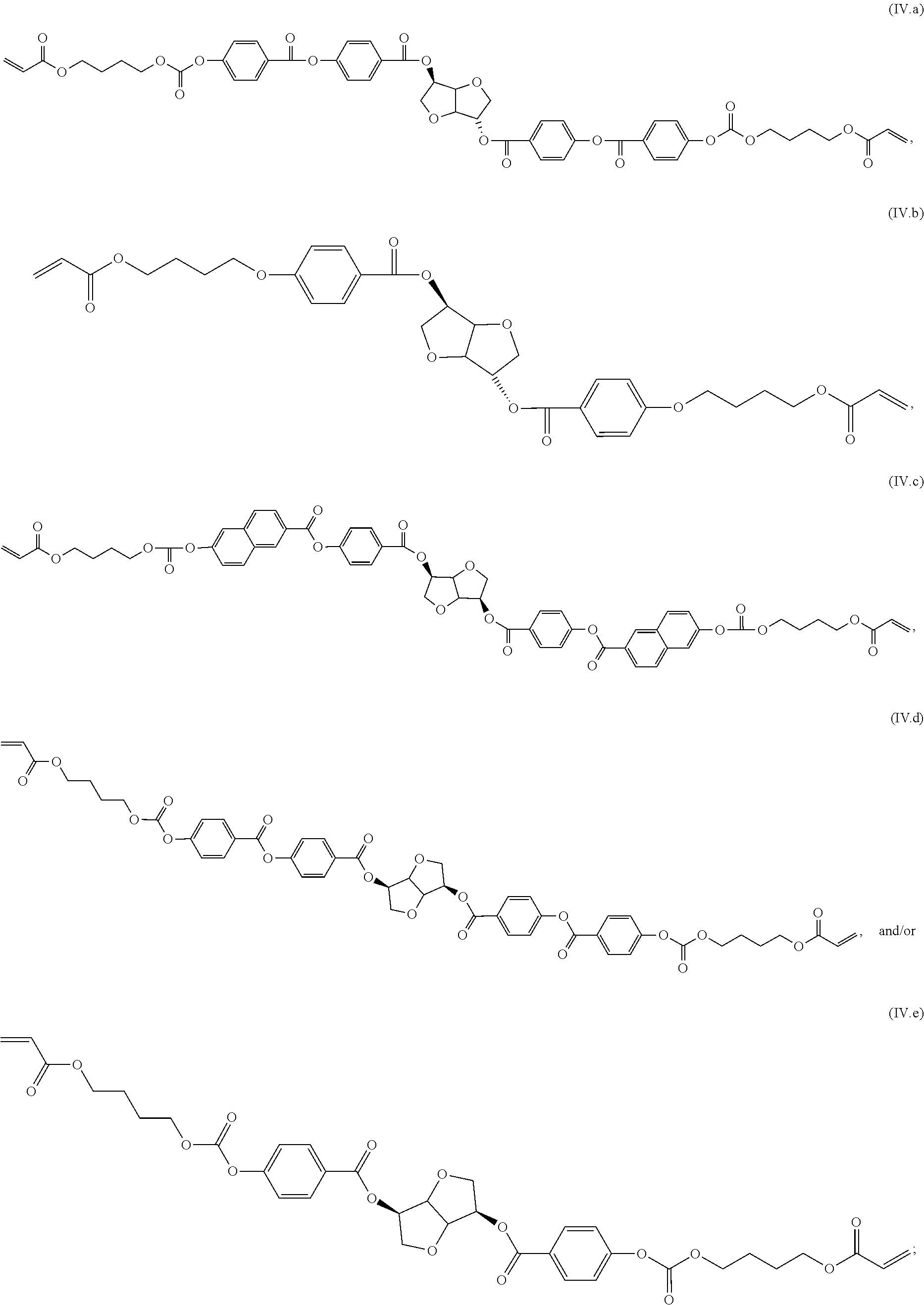
wherein the substance comprises the photoinitiator, solvent leveling agent, and in-can stabilizer.

8. The process of claim 1, wherein the polyurethane (A) has a formula 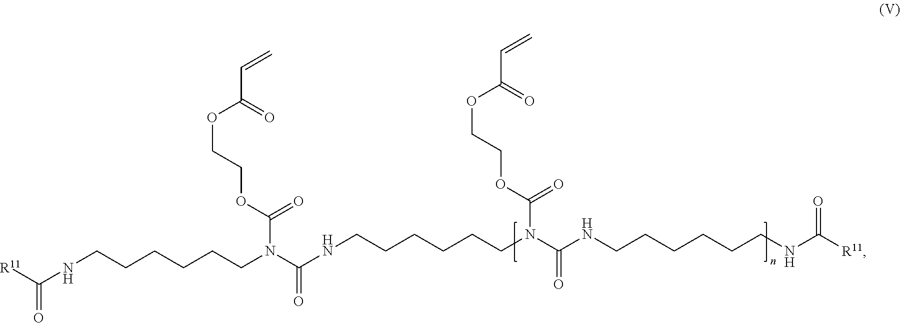
wherein n is a positive number which is on average 1 up to 5, and R¹¹ is a group of formula 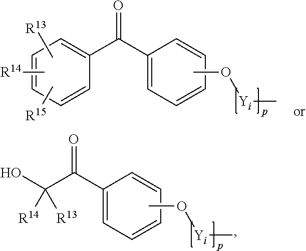
wherein
R¹³, R¹⁴, and R¹⁵ are independently H, an alkyl group comprising 1 to 4 carbon atoms, or an alkyloxy group comprising 1 to 4 carbon atoms,
p is 0 or an integer in a range of from 1 to 10, and
Yᵢ, for i being 1 to p, is independently —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, or —CHPh-CH₂—O—, Ph being phenyl and Yin being vinyl.

9. The process of claim 8, wherein the polymerizable compound (B) is 1,2-propanediol diacrylate, 1,3-propanediol diacrylate, dipropylene glycol diacrylate, tripropylene glycol diacrylate, polyethylene glycol diacrylate, polyethylene glycol dimethacrylate, trimethylolpropane triacrylate, ditrimethylol tetracrylate, dipentaerythritol hexaacrylate, triacrylate of singly to vigintuply alkoxylated glycerol, or singly to vigintuply alkoxylated pentaerythritol.

10. The process of claim 1, wherein the solvent (b3)) comprises a C₂-C₆alcohol, ether, and/or ether-C₂-C₆alcohol, and optionally water.

11. A security element, comprising:
a flexible substrate;
a primer layer; and
a liquid crystal film;
obtained by the process of claim 1.

12. The element of claim 11,
further comprising:
a black layer;
a white layer;
a metallic layer;
a plasmonic layer;
an embossed layer comprising a diffractive grating;
a micromirror;
a lens;
a magnetic layer;
fluorescent layer;
an interference layer;
a colored layer;
an IR-absorbing layer;
an IR-transparent layer; and/or
a conductive layer.

13. The element of claim 11, wherein the layers might be fully, or partially printed on the security element.

14. A security document, comprising;
the security element of claim 11 configured as a laminate onto the document, or embedded as an optionally windowed thread into the document, or as a window on the document.

15. The document of claim 14, which is a banknote, tax stamp, ID-card, voucher, entrance ticket, or label.

16. A primer composition, comprising:
(b1) a polyurethane (A) comprising, in reacted form, (b1a) an organic polyisocyanate having a functionality of at least 2, (b1b) a compound comprising an isocyanate-reactive group and a radically polymerizable unsaturated group, (b1c) a photoinitiator comprising an isocyanate-reactive group;
(b2) a polyfunctional polymerizable compound (B);
(b3) a solvent,
wherein a proportion of the solvent is 90.0 to 99.5 wt. %, a proportion of the compound (B) and the polyurethane (A) is 10.0 to 0.5 wt. %, and
wherein the proportions of solvent, compound (B), and polyurethane (A) add up to 100 wt.

17. The composition of claim 16, wherein the polyurethane (A) has a formula 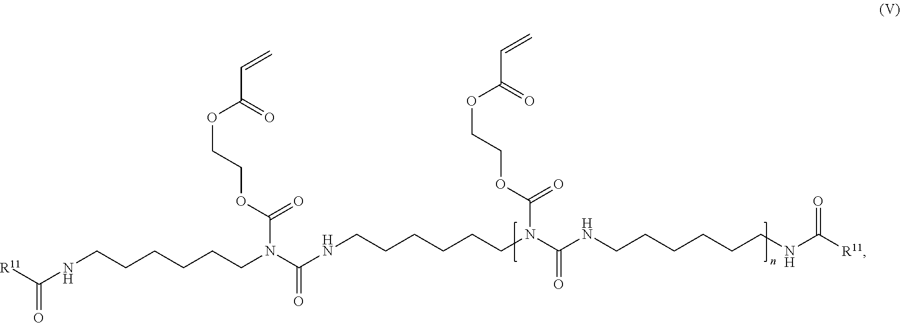
wherein n is a positive number which is on average 1 up to 5, and R¹¹ is a group of formula 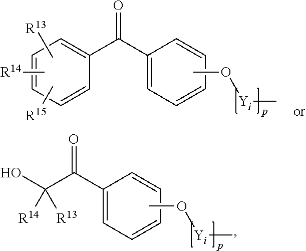
wherein
R¹³, R¹⁴, and R¹⁵ are independently H, an alkyl group comprising 1 to 4 carbon atoms, or an alkyloxy group comprising 1 to 4 carbon atoms,
p is 0 or an integer in a range of from 1 to 10, and
Yᵢ, for i being 1 to p, is independently —CH₂—CH₂—O—, —CH₂—CH(CH₃)—O—, —CH(CH₃)—CH₂—O—, —CH₂₋C(CH₃)₂—O—, —C(CH₃)₂—CH₂—O—, —CH₂—CHVin-O—, —CHVin-CH₂—O—, —CH₂—CHPh-O—, or —CHPh-CH₂—O—, in which Ph being phenyl and Vin being vinyl.

18. The composition of claim 16, wherein the polymerizable compound (B) is selected from is 1,2-propanediol diacrylate, 1,3-propanediol diacrylate, dipropylene glycol diacrylate, tripropylene glycol diacrylate, polyethylene glycol diacrylate, polyethylene glycol dimethacrylate, trimethylolpropane triacrylate, ditrimethylol tetracrylate, dipentaerythritol hexaacrylate, triacrylate of singly to vigintuply alkoxylated trimethylolpropane, singly to vigintuply alkoxylated glycerol, or singly to vigintuply alkoxylated pentaerythritol.

19. The composition of claim 16, wherein the solvent comprises a C₁-C₆alcohol and/or, ether-C₁-C₆alcohol.
